(19) United States
(12) Patent Application Publication
(10) Pub. No.: US 2021/0360653 A1
(43) Pub. Date: Nov. 18, 2021

(54) SEMI-PERSISTENT SCHEDULING RECEPTION CONFIGURATIONS FOR MULTIPLE DOWNLINK SHARED CHANNELS

(71) Applicant: QUALCOMM Incorporated, San Diego, CA (US)

(72) Inventors: Mostafa Khoshnevisan, San Diego, CA (US); Xiaoxia Zhang, San Diego, CA (US); Jing Sun, San Diego, CA (US); Peter Gaal, San Diego, CA (US); Tao Luo, San Diego, CA (US)

(21) Appl. No.: 17/306,478

(22) Filed: May 3, 2021

Related U.S. Application Data
(60) Provisional application No. 63/025,869, filed on May 15, 2020.

(51) Int. Cl. H04W 72/12; H04W 72/02; H04W 72/04

(52) U.S. Cl. CPC H04W 72/1257; H04W 72/02; H04W 72/1242; H04W 72/0453; H04W 72/0446

(57) ABSTRACT

Methods, systems, and devices for wireless communications are described. A user equipment (UE) may receive, from a first base station, downlink transmissions associated with a first value of a pool index. The UE may receive, from a second base station, downlink transmissions associated with a second value of a pool index. The transmissions associated with the first pool index may overlap (e.g., in time, frequency, or both) with those associated with the second pool index. The UE may then determine (e.g., according to a set of rules) which of the overlapping transmissions to receive. In some examples, the UE may determine which of the overlapping transmissions to received based on the pool index associated with the transmissions.

### CROSS REFERENCE

The present Application for Patent claims the benefit of U.S. Provisional Patent Application No. 63/025,869 by KHOSHNEVISAN et al., entitled “SEMI-PERSISTENT SCHEDULING RECEPTION CONFIGURATIONS FOR MULTIPLE DOWNLINK SHARED CHANNELS,” filed May 15, 2020, assigned to the assignee hereof, and expressly incorporated by reference herein.

### FIELD OF TECHNOLOGY

The following relates generally to wireless communications and more specifically to semi-persistent scheduling (SPS) reception configurations for multiple downlink shared channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, multiple base stations may configure a UE for receiving periodic downlink traffic according to a semi-persistent scheduling (SPS) configuration. For example, the SPS configuration may include periodic downlink messages transmitted by a base station on a physical downlink shared channel (PDSCH) (every slot, every second slot, every fourth slot, etc.). In some cases, however, a UE may be scheduled to receive transmissions from multiple base stations and SPS transmissions may overlap with one another, or with other PDSCHs (e.g., dynamically scheduled PDSCH(s)) in time, frequency, or both. In such cases, the UE may not have the capability or may not be configured to receive the overlapping transmissions, which may lead to one or more PDSCH(s), or in some cases all PDSCHs being lost or otherwise unsuccessfully decoded.

### SUMMARY

The described techniques relate to improved methods, systems, devices, and apparatuses that support semi-persistent scheduling (SPS) reception configurations for multiple downlink shared channels. Generally, the described techniques enable a user equipment (UE) to receive, from a first base station, SPS downlink transmissions (e.g., physical downlink shared channel (PDSCH) transmissions) according to a first periodicity and associated with a first value of a pool index, which may indicate to the UE which base station is transmitting the SPS downlink transmissions. The UE may receive SPS downlink transmissions associated with a second value of a pool index according to a second periodicity from a second base station. The SPS transmissions associated with the first pool index may overlap (e.g., in time) with those associated with the second pool index. The UE may then determine (e.g., according to a set of rules) which of the overlapping SPS transmissions to receive. In some examples, a dynamic PDSCH (e.g., PDSCH scheduled by a dynamic grant) associated with a pool index may overlap (e.g., in time, frequency, or both) with an SPS transmission associated with the same or a different pool index. The UE may determine whether to receive or drop one or more of the PDSCHs based on the pool index associated with the dynamic PDSCH and the control message used to schedule the dynamic PDSCH, among other factors.

A method of wireless communications at a UE is described. The method may include activating a set of SPS configurations for a set of downlink shared channels for the UE, the set of downlink shared channels associated with a first pool index, receiving a control message that indicates time-frequency resources for a second downlink shared channel for the UE, the second downlink shared channel associated with a second pool index, determining whether to receive at least one of the set of downlink shared channels or the second downlink shared channel based on a time overlap of the set of downlink shared channels and the second downlink shared channel, and receiving the at least one of the set of downlink shared channels, the second downlink shared channel, or both based on the determining.

An apparatus for wireless communications at a UE is described. The apparatus may include a processor, memory coupled with the processor, and instructions stored in the memory. The instructions may be executable by the processor to cause the apparatus to activate a set of SPS configurations for a set of downlink shared channels for the UE, the set of downlink shared channels associated with a first pool index, receive a control message that indicates time-frequency resources for a second downlink shared channel for the UE, the second downlink shared channel associated with a second pool index, determine whether to receive at least one of the set of downlink shared channels or the second downlink shared channel based on a time overlap of the set of downlink shared channels and the second downlink shared channel, and receive the at least one of the set of downlink shared channels, the second downlink shared channel, or both based on the determining.

Another apparatus for wireless communications at a UE is described. The apparatus may include means for activating a set of SPS configurations for a set of downlink shared channels for the UE, the set of downlink shared channels associated with a first pool index, receiving a control message that indicates time-frequency resources for a second downlink shared channel for the UE, the second downlink shared channel associated with a second pool index, determining whether to receive at least one of the set of downlink shared channels or the second downlink shared channel based on a time overlap of the set of downlink shared channels and the second downlink shared channel, and receiving the at least one of the set of downlink shared channels, the second downlink shared channel, or both based on the determining.

A non-transitory computer-readable medium storing code for wireless communications at a UE is described. The code may include instructions executable by a processor to activate a set of SPS configurations for a set of downlink shared channels for the UE, the set of downlink shared channels associated with a first pool index, receive a control message that indicates time-frequency resources for a second downlink shared channel for the UE, the second downlink shared channel associated with a second pool index, determine whether to receive at least one of the set of downlink shared channels or the second downlink shared channel based on a time overlap of the set of downlink shared channels and the second downlink shared channel, and receive the at least one of the set of downlink shared channels, the second downlink shared channel, or both based on the determining.

Some examples of the method, apparatuses, and non-transitory computer-readable medium described herein may further include operations, features, means, or instructions for determining to receive a first downlink shared channel of the set of downlink shared channels over a third downlink shared channel of the set of downlink shared channels based on a SPS configuration index associated with the first downlink shared channel being lower than a SPS configuration index associated with the third downlink shared channel.

Some examples of the method, apparatuses, and non-transitory computer-readable medium described herein may further include operations, features, means, or instructions for activating a second set of SPS configurations for a second set of downlink shared channels associated with the second pool index and including the second downlink shared channel based on the control message and one or more additional control messages, and determining to receive the second downlink shared channel over a third downlink shared channel of the second set of downlink shared channels based on an SPS configuration index associated with the second downlink shared channel being lower than an SPS configuration index associated with the third downlink shared channel.

Some examples of the method, apparatuses, and non-transitory computer-readable medium described herein may further include operations, features, means, or instructions for determining to receive a first downlink shared channel over a third downlink shared channel of the set of downlink shared channels based on a priority of the first downlink shared channel being higher than a priority of the third downlink shared channel.

Some examples of the method, apparatuses, and non-transitory computer-readable medium described herein may further include operations, features, means, or instructions for activating a second set of SPS configurations for a second set of downlink shared channels associated with the second pool index and including the second downlink shared channel based on the control message and one or more additional control messages, and determining to receive the second downlink shared channel over a third downlink shared channel of the second set of downlink shared channels based on a priority of the second downlink shared channel being higher than a priority of the third downlink shared channel.

Some examples of the method, apparatuses, and non-transitory computer-readable medium described herein may further include operations, features, means, or instructions for receiving both of a downlink shared channel of the set of downlink shared channels and the second downlink shared channel based on the second downlink shared channel being dynamically scheduled by the control message and the first pool index being different from the second pool index, wherein the downlink shared channel and the second downlink shared channel overlap in time.

Some examples of the method, apparatuses, and non-transitory computer-readable medium described herein may further include operations, features, means, or instructions for determining to refrain from receiving one or more of the set of downlink shared channels based on the second downlink shared channel at least partially overlapping in time with the one or more of the set of downlink shared channels, where the second pool index may be the same as the first pool index.

In some examples of the method, apparatuses, and non-transitory computer-readable medium described herein, a start symbol of the one or more of the set of downlink shared channels may be a threshold number of symbols apart from an end of the control message.

Some examples of the method, apparatuses, and non-transitory computer-readable medium described herein may further include operations, features, means, or instructions for receiving a downlink shared channel of the set of downlink shared channels or the second downlink shared channel according to a set of rules based on the downlink shared channel and the second downlink shared channel at least partially overlapping in both time and frequency.

In some examples of the method, apparatuses, and non-transitory computer-readable medium described herein, the set of rules indicates that only downlink shared channels associated with a given pool index may be to be received by the UE based on demodulation reference signal (DMRS) symbols of the downlink shared channel and the second downlink shared channel being misaligned.

In some examples of the method, apparatuses, and non-transitory computer-readable medium described herein, the set of rules indicates that only downlink shared channels associated with a given pool index may be to be received by the UE based on one or more DMRS ports of the downlink shared channel and one or more DMRS ports of the second downlink shared channel belonging to a same DMRS code division multiplexing (CDM) group.

Some examples of the method, apparatuses, and non-transitory computer-readable medium described herein may further include operations, features, means, or instructions for receiving both of a downlink shared channel of the set of downlink shared channels and the second downlink shared channel independent of an alignment between demodulation reference signal (DMRS) symbols of the downlink shared channel and DMRS symbols of the second downlink shared channel and independent of one or more DMRS ports of the downlink shared channel and one or more DMRS ports of the second downlink shared channel belonging to a same DMRS code division multiplexing (CDM) group, where the downlink shared channel and the second downlink shared channel at least partially overlap in both time and frequency, and where the first pool index may be different from the second pool index.

In some examples of the method, apparatuses, and non-transitory computer-readable medium described herein, the second downlink shared channel is associated with a semi-persistently scheduled downlink shared channel.

Some examples of the method, apparatuses, and non-transitory computer-readable medium described herein may further include operations, features, means, or instructions for receiving both of a downlink shared channel of the set of downlink shared channels and the second downlink shared channel based on the first pool index being different from the second pool index.

Some examples of the method, apparatuses, and non-transitory computer-readable medium described herein may further include operations, features, means, or instructions for activating a second set of SPS configurations for a second set of downlink shared channels associated with the second pool index and including the second downlink shared channel based on the control message and one or more additional control messages, determining to receive a first downlink shared channel over a third downlink shared channel of the set of downlink shared channels based on an SPS configuration index associated with the first downlink shared channel being lower than an SPS configuration index associated with the third downlink shared channel, and determining to refrain from receiving one or more of the second set of downlink shared channels based on the one or more of the second set of downlink shared channels at least partially overlapping in time and frequency with the first downlink shared channel.

In some examples of the method, apparatuses, and non-transitory computer-readable medium described herein, DMRS symbols of the first downlink shared channel and the one or more of the second set of downlink shared channels may be misaligned.

In some examples of the method, apparatuses, and non-transitory computer-readable medium described herein, one or more DMRS ports of the first downlink shared channel and one or more DMRS ports of the one or more of the second set of downlink shared channels belong to a same DMRS CDM group.

Some examples of the method, apparatuses, and non-transitory computer-readable medium described herein may further include operations, features, means, or instructions for determining to receive a fourth downlink shared channel over a fifth downlink shared channel of remaining downlink shared channels of the second set of downlink shared channels based on a SPS configuration index associated with the fourth downlink shared channel being lower than a SPS configuration index associated with the fifth downlink shared channel.

Some examples of the method, apparatuses, and non-transitory computer-readable medium described herein may further include operations, features, means, or instructions for receiving the second downlink shared channel based on the second downlink shared channel being dynamically scheduled by the control message and at least partially overlapping in both time and frequency with at least one of the set of downlink shared channels, and refraining from receiving the at least one downlink shared channel of the set of downlink shared channels.

In some examples of the method, apparatuses, and non-transitory computer-readable medium described herein, DMRS symbols of the at least one downlink shared channel and the second downlink shared channel may be misaligned.

In some examples of the method, apparatuses, and non-transitory computer-readable medium described herein, a start symbol of the at least one downlink shared channel may be a threshold number of symbols apart from an end of the control message.

In some examples of the method, apparatuses, and non-transitory computer-readable medium described herein, one or more DMRS ports of the downlink shared channel and one or more DMRS ports of the second downlink shared channel belong to a same DMRS CDM group.

Some examples of the method, apparatuses, and non-transitory computer-readable medium described herein may further include operations, features, means, or instructions for receiving at least one of the set of downlink shared channels and the second downlink shared channel based on the second downlink shared channel at least partially overlapping in both time and frequency with the at least one of the set of downlink shared channels.

Some examples of the method, apparatuses, and non-transitory computer-readable medium described herein may further include operations, features, means, or instructions for transmitting an indication of a number of shared channels capable of being received by the UE, and determining to receive one or more of the set of downlink shared channels or the second downlink shared channel based on the number of shared channels capable of being received by the UE.

In some examples of the method, apparatuses, and non-transitory computer-readable medium described herein, the indication includes a first number of shared channels of the first pool index capable of being received by the UE, and the indication includes a second number of shared channels of the second pool index capable of being received by the UE.

### BRIEF DESCRIPTION OF THE DRAWINGS

FIG. 1 illustrates an example of a wireless communications system that supports semi-persistent scheduling (SPS) reception configurations for multiple downlink shared channels in accordance with aspects of the present disclosure.

FIG. 2 illustrates an example of a wireless communications system that supports SPS reception configurations for multiple downlink shared channels in accordance with aspects of the present disclosure.

FIGS. 3A, 3B, and 3C illustrate examples of resource sets that support SPS reception configurations for multiple downlink shared channels in accordance with aspects of the present disclosure.

FIGS. 4A, 4B, and 4C illustrate examples of resource sets that support SPS reception configurations for multiple downlink shared channels in accordance with aspects of the present disclosure.

FIGS. 5A, 5B, and 5C illustrate examples of resource sets that support SPS reception configurations for multiple downlink shared channels in accordance with aspects of the present disclosure.

FIG. 6 illustrates an example of a process flow that supports SPS reception configurations for multiple downlink shared channels in accordance with aspects of the present disclosure.

FIGS. 7 and 8 show block diagrams of devices that support SPS reception configurations for multiple downlink shared channels in accordance with aspects of the present disclosure.

FIG. 9 shows a block diagram of a communications manager that supports SPS reception configurations for multiple downlink shared channels in accordance with aspects of the present disclosure.

FIG. 10 shows a diagram of a system including a device that supports SPS reception configurations for multiple downlink shared channels in accordance with aspects of the present disclosure.

FIGS. 11 through 16 show flowcharts illustrating methods that support SPS reception configurations for multiple downlink shared channels in accordance with aspects of the present disclosure.

### DETAILED DESCRIPTION

In some wireless communications systems, a base station may use semi-static grants to schedule multiple downlink transmissions to a user equipment (UE). Such scheduling may be referred to as semi-persistent scheduling (SPS) and may be used to limit overhead and processing latency in a wireless communications system (e.g., because semi-static grants may be transmitted less frequently than dynamic grants). An SPS configuration may include periodic downlink messages transmitted by a base station on a physical downlink shared channel (PDSCH). Base stations configuring a UE with SPS resources may do so by transmitting semi-static control signaling (e.g., via a radio resource control (RRC) message) to the UE and may activate an SPS configuration associated with a set of SPS resources more dynamically (e.g., using downlink control information (DCI) carried by a physical downlink control channel (PDCCH) to activate or deactivate an SPS configuration for the UE). In some cases, a UE may be configured to receive PDSCH transmissions (e.g., SPS PDSCH or dynamic PDSCH) from more than one base station (e.g., multiple transmission reception points (TRPs)). In such cases, each PDSCH transmission may be associated with a respective pool index value corresponding to the base station performing the transmission. However, the UE may receive SPS PDSCHs associated with a first pool index value that overlap (e.g., in time, frequency, or both) with other PDSCHs (other SPS PDSCHs or other dynamically scheduled PDSCHs) of the same or different pool index value. In some cases, the UE may not support decoding of overlapping PDSCH transmissions associated with different pool index values.

As described herein, a wireless communications system may support techniques for successfully decoding SPS downlink transmissions and dynamic downlink transmissions associated with different pool index values that may overlap in time, frequency, or both. In one example, a UE may receive SPS PDSCHs associated with a first pool index that overlap in time. The UE may receive SPS PDSCHs associated with a second pool index that overlap in time. The UE may determine which overlapping SPS PDSCHs to drop among the first pool index and which overlapping SPS PDSCHs to drop among the second pool index. Once overlapping SPS PDSCHs are resolved within each pool index, the UE may receive any surviving SPS PDSCHs.

In another example, a UE may receive an SPS PDSCH associated with a first pool index and a dynamic PDSCH associated with a second pool index, where both PDSCHs overlap in time. The UE may determine whether the SPS PDSCH transmission is received based on the pool index associated with the dynamic PDSCH. For example, if the dynamic PDSCH and SPS transmission are associated with the same pool index, the UE may determine to receive only the dynamic PDSCH. If, however, the dynamic PDSCH and the SPS transmission are associated with different pool indices, the UE may determine to receive both transmissions.

In some cases, a UE may receive SPS PDSCHs and one or more dynamic PDSCHs. The SPS PDSCHs may overlap with one another and with dynamic PDSCHs in time, frequency, or both. In such cases, the UE may determine which SPS PDSCH to receive of the overlapping SPS PDSCHs, or may determine to receive both SPS PDSCHs so long as they are each associated with different pool indices. If SPS PDSCHs overlap with dynamic PDSCHs in time and frequency, the UE may determine whether the SPS PDSCH transmission is received based on the pool index associated with the dynamic PDSCH. As described herein, SPS PDSCHs may be referred to as PDSCHs without a corresponding PDCCH whereas dynamic PDSCHs may be scheduled via DCI within a PDCCH and therefore may be referred to as having a corresponding PDCCH.

Aspects of the disclosure are initially described in the context of wireless communications systems. Aspects of the disclosure are then described with reference to resource sets and a process flow. Aspects of the disclosure are further illustrated by and described with reference to apparatus diagrams, system diagrams, and flowcharts that relate to SPS reception configurations for multiple downlink shared channels.

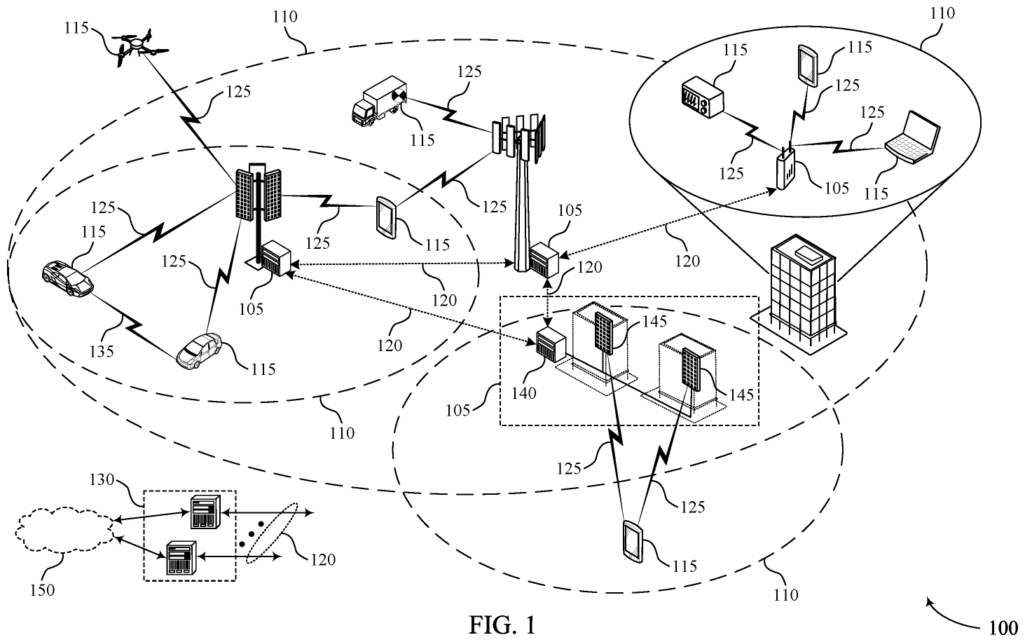

FIG. 1 illustrates an example of a wireless communications system 100 that supports SPS reception configurations for multiple downlink shared channels in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

One or more base stations 105 may transmit semi-static control signaling to schedule periodic downlink traffic according to an SPS configuration. The configuration may include various parameters, such as a periodicity, allocated resources, a modulation and coding scheme (MCS), or the like. The semi-static control signaling may also include SPS activation state information indicating whether a UE 115 is to activate SPS configurations and, if so, which SPS configurations the UE 115 is to activate. The UE 115 may receive SPS transmissions (e.g., on a PDSCH) based on the configuration until the UE 115 is instructed to release the SPS configuration (e.g., via an SPS release control message which may be included in DCI).

In cases where multiple base stations 105 are configuring a UE 115 with SPS transmissions, the UE 115 may determine a respective pool index value associated with each base station 105. The UE 115 may receive SPS PDSCHs associated with the pool index value corresponding to the transmitting base station 105. In some examples, SPS PDSCHs may overlap in time, frequency, or both. In such situations, the UE 115 may determine which PDSCH(s) of the overlapping PDSCHs to decode based on associated pool index values, SPS configuration indices, priority levels, or other considerations.

As an example, a UE 115 may receive a first set of SPS PDSCHs associated with a first pool index that overlap in time and a second set of SPS PDSCHs associated with a second pool index that overlap in time. The UE 115 may determine which overlapping SPS PDSCHs to drop among those associated with the first pool index and which overlapping SPS PDSCHs to drop among those associated with the second pool index. Once overlapping SPS PDSCHs are resolved within each pool index, the UE 115 may receive any surviving SPS PDSCHs. If the overlapping SPS PDSCHs are instead associated with different pool indices (e.g., associated with different transmitting base stations 105), the UE 115 may receive all SPS PDSCHs.

In another example, a UE 115 may receive SPS PDSCHs and dynamic PDSCHs that overlap in time. The UE 115 may determine whether the SPS PDSCH transmission is received based on the pool index associated with the dynamic PDSCH. For example, if the dynamic PDSCH and SPS transmission are associated with the same pool index (e.g., associated with the same transmitting base station 105), the UE 115 may determine to receive only the dynamic PDSCH. If, however, the dynamic PDSCH and the SPS transmission are associated with different pool indices, the UE 115 may determine to receive both transmissions. In some cases, a UE 115 may receive SPS PDSCHs and one or more dynamic PDSCHs, and the SPS PDSCHs may overlap with one another and with dynamic PDSCHs in time, frequency, or both. In such cases, the UE 115 may determine which SPS PDSCH to receive of the overlapping SPS PDSCHs, or may determine to receive both SPS PDSCHs so long as they are each associated with different pool indices. If SPS PDSCHs overlap with dynamic PDSCHs in time and frequency, the UE 115 may determine whether the SPS PDSCH transmission is received based on the pool index associated with the dynamic PDSCH.

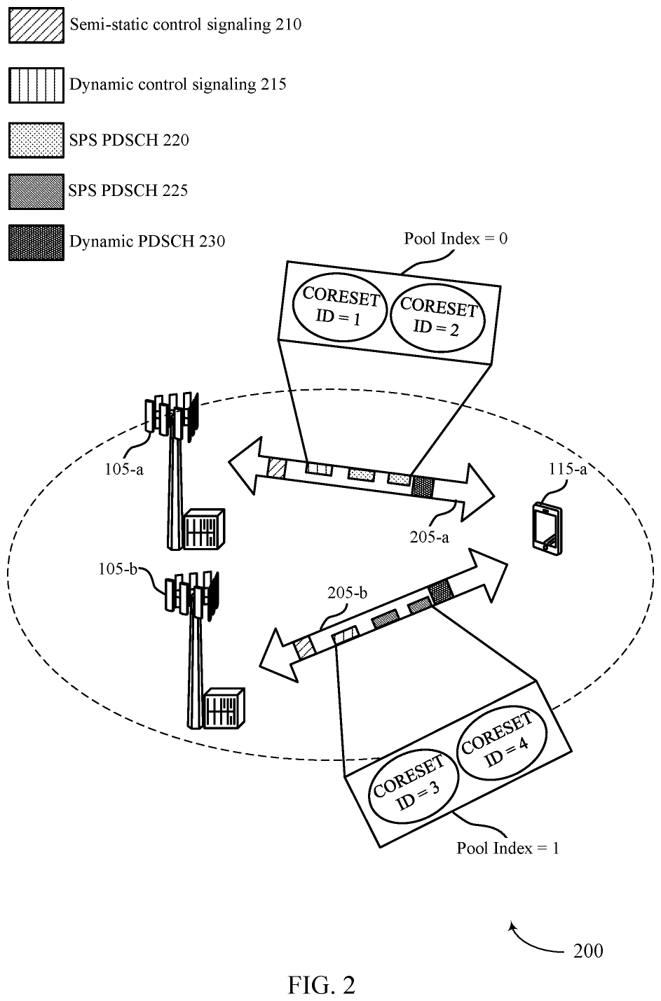

FIG. 2 illustrates an example of a wireless communications system 200 that supports SPS reception configurations for multiple downlink shared channels in accordance with aspects of the present disclosure. In some examples, wireless communications system 200 may implement aspects of wireless communication system 100. For example, wireless communications system 200 may include base stations 105-a and 105-b and a UE 115-a, which may be examples of corresponding base stations 105 and UEs 115, respectively, as described herein with reference to FIG. 1.

Base stations 105-a and 105-b may communicate with UE 115-a through communication links 205-a and 205-b, respectively. For instance, base station 105-a may transmit dynamic control signaling 215 (e.g., DCI signaling) to schedule a dynamic PDSCH 230. The base station 105-a may transmit semi-static control signaling 210 (e.g., RRC signaling) to configure the UE 115-a with one or more SPS configurations. Semi-static control signaling 210 may include SPS activation state information indicating whether UE 115-a is to activate SPS configurations and, if so, which SPS configurations UE 115-a is to activate. UE 115-a may receive the semi-static control signaling 210 and determine to activate an SPS configuration including SPS PDSCH 220 based on the SPS activation state information. Base station 105-b may also transmit semi-static control signaling 210 and dynamic control signaling 215 for an SPS PDSCH 225 and a dynamic PDSCH 230, respectively. In some cases, semi-static control signaling 215 may indicate that UE 115-a is to deactivate all SPS configurations or is to abstain from activating any SPS resources based on the SPS activation state information.

An SPS configuration indicated by semi-static control signaling 210 may be associated with an index value (e.g., an sps-ConfigIndex value) and may include various parameters. The SPS configuration may be activated by a DCI message (e.g., with a cyclic redundancy check (CRC) scrambled with a configured scheduling radio network temporary identifier (CS-RNTI) and a new data indicator (NDI) set to 0). RRC signaling may indicate some parameters of an SPS configuration, while the activation DCI may indicate other parameters. RRC signaling may indicate a periodicity, a number of associated HARQ processes, or the like. In an activation DCI, a HARQ process number field may not be used and thus may be replaced with an indication of the SPS configuration to be activated. The activation DCI may indicate time and frequency resources for each SPS PDSCH, as well as an MCS, a time domain resource assignment (e.g., a K1 value), etc. An SPS configuration activation may trigger SPS PDSCH transmissions. The UE 115-a may receive SPS PDSCH transmissions based on the configured periodicity until another DCI releases the SPS configuration.

Base station 105-a may transmit DCI in dynamic control signaling 215 to UE 115-a to schedule dynamic PDSCH 230. In some cases, the DCI may also activate an SPS configuration, which may trigger the SPS PDSCHs associated with the configuration. For example, the UE 115-a may receive a DCI indicating activation of a configuration associated with SPS PDSCH 220. In either case, the DCI may be received via a CORESET. The CORESET may be associated with a pool index value, which may correspond to the transmitting base station (e.g., base station 105-a). For example, a first DCI with a pool index value of 0 may correspond to base station 105-a. UE 115-a may determine the transmitting base station based on the pool index value. CORESETs within a given pool index value may each have a CORESET ID. For example, a first and second CORESET within a pool index value of 0 may have CORESET identifiers (IDs) of 1 and 2, respectively, while a first and second CORESET within a pool index value of 1 may have CORESET IDs of 3 and 4, respectively. The pool index value of the CORESET in which a DCI is received may be used for various purposes, such as HARQ codebook construction and transmission, PDSCH scrambling, rate matching, etc.

An SPS PSDCH 220 or an SPS PDSCH 225 may be associated with a pool index value corresponding to the transmitting base station. That is, each SPS PDSCH 220 or SPS PDSCH 225 may be associated with a pool index value depending on the CORESET in which the DCI activating the SPS configuration is received. For example, SPS PDSCH 220 may be associated with a pool index value of 0 corresponding to base station 105-a, and SPS PDSCH 225 may be associated with a pool index value of 1 corresponding to base station 105-b. In some cases, the configuration for each SPS PDSCH 220 or SPS PDSCH 225 may also include a periodicity (e.g., an SPS downlink interval). For example, the periodicity may be 2 OFDM symbols, 7 OFDM symbols, one slot, 2 slots, 4 slots, 5 slots, 8 slots, 10 slots, 16 slots, 20 slots, 32 slots, 40 slots, 64 slots, 80 slots, 128 slots, 160 slots, 320 slots, 640 slots, etc.

In some cases, resources assigned to SPS PDSCH 220, SPS PDSCH 225, and dynamic PDSCH 230 by their corresponding base stations may overlap in time, frequency, or both. In such situations, the UE 115-a may determine which PDSCH(s) of the overlapping PDSCHs to decode based on associated pool index values, SPS configuration indices, priority levels, or other factors. For example, the UE 115-a may receive both SPS PDSCH 220 and SPS PDSCH 225 that overlap in time, provided SPS PDSCH 220 is associated with a pool index value different from that of SPS PDSCH 225. Additionally or alternatively, if SPS PDSCH 220 overlaps in time with dynamic PDSCH 230 and both are associated with the same pool index value, the UE 115-a may determine to decode PDSCH 230 and drop SPS PDSCH 220.

In some examples, the UE 115-a may receive SPS PDSCHs of various SPS configurations but associated with the same pool index value. As a result, there may occur, in a single slot, overlap (e.g., in time, frequency, or both) among SPS PDSCHs of different SPS configurations. For example, the UE 115-a may receive SPS PDSCH 220 (e.g., associated with a pool index value of 0) and SPS PDSCH 225 of a different SPS configuration (e.g., associated with a pool index value of 1), and the two SPS PDSCHs may overlap in time. The UE 115-a may determine (e.g., based on associated SPS configuration index values, a priority level, etc.) to decode SPS PDSCH 220 and may drop the SPS PDSCH 225. If the UE 115-a receives overlapping SPS PDSCHs associated with a first pool index value and overlapping SPS PDSCHs associated with a second pool index value, and if the SPS PDSCHs also overlap across pool index values, the UE 115-a may resolve overlaps among SPS PDSCHs of the first pool index value separately from overlaps among SPS PDSCHs of the second pool index value. After resolving overlaps within each pool index value, the UE 115-a may determine which SPS PDSCH(s) to receive across pool index values.

If SPS PDSCH 220, SPS PDSCH 225, and dynamic PDSCH 230 overlap in both time and frequency, the UE 115-a may resolve overlapping PDSCHs by first determining whether the DMRS symbols of the overlapping PDSCHs are aligned or whether the DMRS ports of the overlapping PDSCHs belong to different code division multiplexing (CDM) groups. If the DMRS symbols are not aligned or the DMRS ports belong to the same CDM group, the UE 115-a may decode only one of the overlapping PDSCHs (e.g., according to a rule) or may decode all overlapping PDSCHs. In some cases, the UE 115-a may determine to decode dynamic PDSCH 230 and drop the SPS PDSCHs 220 and 225.

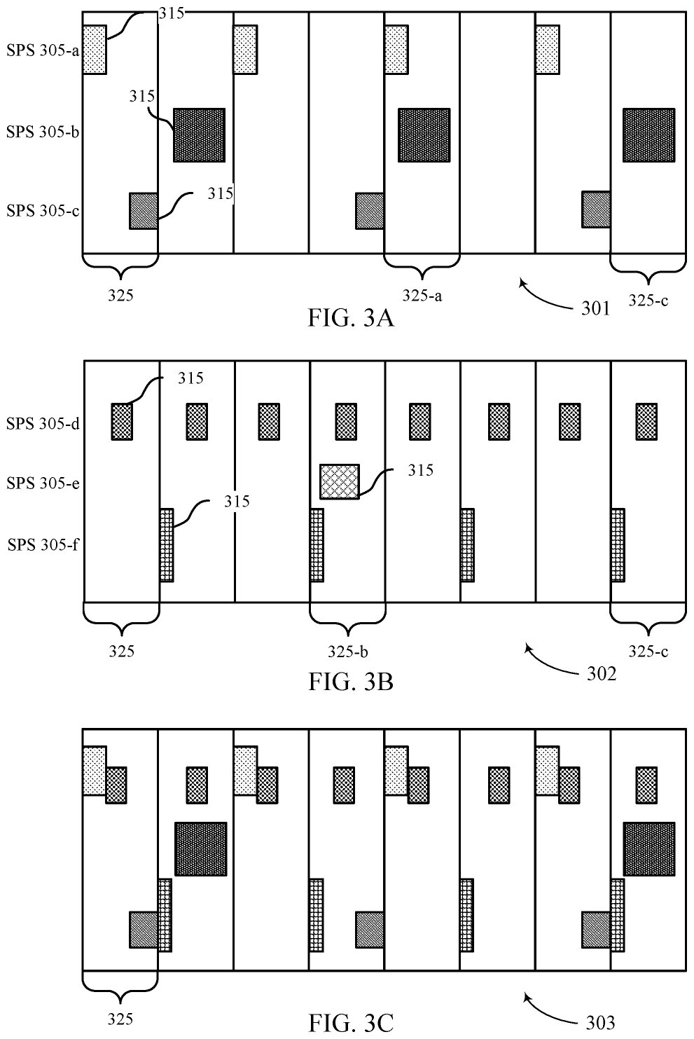

FIGS. 3A, 3B, and 3C illustrate examples of resource sets 301, 302, and 303 that support SPS reception configurations for multiple downlink shared channels in accordance with aspects of the present disclosure. In some examples, resource sets 301, 302, and 303 may implement aspects of wireless communication systems 100 and 200. For example, resource sets 301, 302, and 303 may be configured and transmitted by one or more base stations and may be received by a UE, which may be examples of base stations 105 and a UE 115 as described with reference to FIGS. 1 and 2, respectively.

One or more base stations may transmit one or more SPS configurations 305 to a UE for a resource set 300. Each SPS configuration 305 may include various parameters (e.g., a periodicity, an SPS configuration index, a set of time or frequency resources, etc.) and may be activated by a DCI message transmitted from the corresponding base station. For example, a first base station may transmit a message including an SPS configuration 305 indicating a set of time-frequency resources for PDSCH transmissions 315 according to a periodicity. The base station may transmit a DCI message instructing the UE to activate the SPS configuration 305 and the UE may begin to receive PDSCHs 315 accordingly.

In some cases, the UE may be configured with multiple pool index values, such that transmissions (such as SPS configurations 305) from a base station may be associated with a pool index value corresponding to the base station. For example, resource set 301 illustrated in FIG. 3A may be received, by the UE, at the same time as resource set 302 illustrated in FIG. 3B. However, resource set 301 may be received from a base station different than the base station transmitting resource set 302. As such, SPS configurations 305 received on resource set 301 may be associated with a pool index value different than SPS configurations 305 received on resource set 302. For example, FIG. 3A illustrates a resource set 301 for a set of SPS configurations 305 associated with a pool index value of 0, while FIG. 3B illustrates a resource set 302 for a second set of SPS configurations 305 associated with a pool index value of 1.

The UE may receive SPS downlink messages on PDSCHs 315 that occur at regular intervals (e.g., in numbers of slots 325) in each SPS 305. In some examples, the UE may receive multiple PDSCHs 315 from multiple SPS configurations 305 in a single slot 325. For example, as illustrated in FIG. 3A, a first SPS 305-a may be configured with PDSCHs 315 that occur every second slot 325, a second SPS 305-b with PDSCHs 315 that occur every third slot 325, and a third SPS 305-c with PDSCHs 315 that occur every fourth slot 325. Similarly, FIG. 3B illustrates an SPS 305-d configured with PDSCHs 315 that occur every third slot, an SPS 305-e configured with PDSCHs 315 that occur every sixth slot, and an SPS 305-f configured with PDSCHs 315 that occur every second slot. Thus, the UE may receive, in a single slot, multiple PDSCHs 315 from various SPS configurations 305 and associated with various pool indices. While slots 325 are shown for each SPS 305, it is to be understood that the SPSs 305 may include periodicities that occur at different length intervals (e.g., other TTIs, mini-slots, etc.).

As described herein, the UE may receive SPSs 305 associated with different pool index values where the PDSCHs 315 may overlap in time in a slot. For example, in slot 325-a, a PDSCH 315 from SPS 305-a overlaps in time with a PDSCH 315 from SPS 305-b. Similarly, in slot 325-b, a PDSCH 315 from each of SPS 305-d, 305-e, and 305-f overlap in time. Further, in slot 325-c, a PDSCH 315 from SPS 305-b in resource set 301 overlaps in time with a PDSCH 315 from SPS 305-d in resource set 302. The UE may resolve conflicts in overlapping PDSCHs 315 by first resolving overlapping PDSCHs 315 associated with a first pool index and then resolving overlapping PDSCHs 315 associated with a second pool index. For example, for each pool index value, the UE may select one or more PDSCHs 315 from the set of overlapping PDSCHs 315 to decode, and may drop the other PDSCHs 315. The selection may be based on various conditions determined by the UE. The UE may receive PDSCHs 315 that overlap in time in a slot 325, provided the overlapping PDSCHs 315 are associated with different pool index values. For instance, in slot 325-c, the UE may receive PDSCH 315 of SPS 305-b (e.g., associated with a pool index value of 0) and PDSCH 315 of SPS 305-d (e.g., associated with a pool index value of 1).

As an example, in slot 325-a of resource set 301, the UE may first resolve overlapping within symbols (i.e., overlap in time) in the slot 325-a. The UE may then determine the number of PDSCHs 315 in the slot 325-a (e.g., two) and determine a set Q₀ that includes the PDSCHs 315 in the slot 325-a. Of the set Q₀, the UE may determine an SPS configuration index associated with each PDSCH 315. For example, PDSCH 315 of SPS 305-a may be configured with an SPS configuration index value of 0, and PDSCH 315 of SPS 305-c may be configured with an SPS configuration index value of 2. The UE may then select to receive a PDSCH 315 in slot 325-a based on the SPS configuration index value. As an example, the UE may choose to receive the PDSCH 315 associated with the lowest SPS configuration index value (e.g., PDSCH 315 of SPS 305-a). The UE may discard the unselected PDSCH 315.

Similarly, the UE may resolve overlapping PDSCHs 315 in slot 325-b of resource set 302. PDSCH 315 from each of SPS 305-d, 305-e, and 305-f, which have been received in slot 325-b. PDSCH 315 of SPS 305-e overlaps in time with the PDSCH 315 from SPS 305-d and the PDSCH 315 from SPS 305-f. The UE may follow the same procedure in this case as in resource set 301. The UE may determine a set Q₁ that includes the PDSCHs 315 in the slot 325-c and may determine an SPS configuration index associated with each PDSCH 315 within Q₁. As an example, the PDSCH 315 associated with SPS 305-d may have an SPS configuration index value of 0, the PDSCH 315 associated with SPS 305-e may have an SPS configuration index value of 1, and the PDSCH 315 associated with SPS 305-f may have an SPS configuration index value of 2. The UE may select to receive the PDSCH 315 in the slot 325-b associated with the lowest SPS configuration index value (e.g., PDSCH 315 associated with SPS 305-d).

After receiving the selected PDSCH 315, UE may remove the selected PDSCH 315 from the set Q₁ as well as any PDSCHs 315 overlapping with the selected PDSCH 315. In this example, the UE may select to receive the PDSCH 315 associated with SPS 305-d, and may remove that PDSCH 315 from the set Q₁. The UE may also remove PDSCH 315 associated with SPS 305-e in slot 325-b, as it overlaps in time with the selected PDSCH 315. The UE may not decode the PDSCH 315 associated with SPS 305-e. After the removal, the set Q₁ includes only the PDSCH 315 associated with SPS 305-f, which does not overlap in time with the remaining PDSCH 315. As such, the PDSCH associated with SPS 305-f may be decoded by the UE.

The UE may be capable of supporting a maximum number of unicast PDSCHs per index pool value in a slot, and may indicate this capability to a base station (e.g., via UE capability signaling). For example, the UE may indicate to a base station that the UE is capable of receiving four unicast PDSCHs per pool index in a slot. Alternatively, the UE may indicate a total number of PDSCHs that the UE is capable of receiving in a slot, and the number of PDSCHs per pool index value in a slot may be inferred from the total number. In cases where the UE supports a maximum number of PDSCHs 315 in a slot 325, the UE may determine the PDSCHs 315 to decode according to the maximum number. For example, the UE may determine to drop PDSCHs 315 according to the techniques described herein until the number of PDSCHs 315 selected for decoding are equal to or less than the maximum number of PDSCHs 315 in a slot supported by the UE.

In some cases, one or more PDSCHs 315 received in a slot may be associated with a priority value or a priority index. The UE may use the priority value in addition to the above-described techniques when determining which PDSCHs 315 to decode or drop within a set Q₀ or Q₁. For example, in slot 325-a (e.g., set Q₀), PDSCH 315 of SPS 305-a may be associated with a lower priority than PDSCH 315 of SPS 305-b, and the UE may thus determine to decode PDSCH 315 of SPS 305-b and may drop PDSCH 315 of SPS 305-a.

Although the examples described herein are described with two or three PDSCHs 315 that overlap in time, the UE may perform the above procedure for any number of overlapping PDSCHs. The UE may determine a set Qᵢ including the overlapping PDSCHs 315 and may select a first PDSCH based on its associated SPS configuration index. The UE may then remove the selected PDSCH 315 and any PDSCHs 315 that overlap in time with the selected PDSCH 315 from the set Q. The UE may repeat the procedure until the number of PDSCHs 315 in the set Qᵢ is equal to zero, or until the number of PDSCHs 315 received in a slot is equal to the number of unicast PDSCHs the UE is capable of receiving in a single slot.

FIG. 3C illustrates an example of a resource set 303 that includes PDSCHs 315 associated with SPS configurations 305-a through 305-f, after the UE has resolved conflicting PDSCHs 315 that overlap in time and are associated with the same pool index value. It is important to note that slot 325-c includes PDSCH 315 associated with SPS 305-d as well as PDSCH 315 associated with SPS 305-b. Although these two PDSCHs 315 overlap in time in slot 325-c, the UE may decode both, as each PDSCH 315 is associated with a different pool index value.

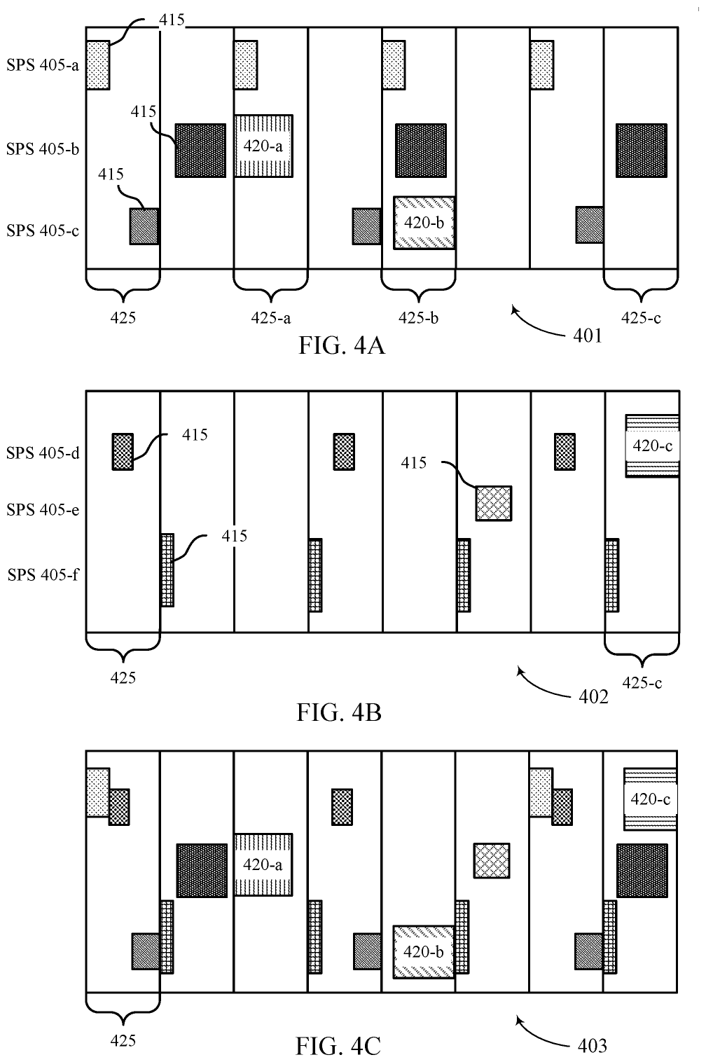

FIGS. 4A, 4B, and 4C illustrate examples of resource sets 401, 402, and 403 that support SPS reception configurations for multiple downlink shared channels in accordance with aspects of the present disclosure. In some examples, resource sets 401, 402, and 403 may implement aspects of wireless communication systems 100 and 200. For example, resource sets 401, 402, and 403 may be configured and transmitted by one or more base stations and may be received by a UE, which may be examples of base stations 105 and a UE 115 as described with reference to FIGS. 1 and 2, respectively.

As described herein, one or more base stations may transmit one or more SPS configurations 405 to a UE for a resource set 400. Each SPS configuration 405 may include various parameters (e.g., a periodicity, an SPS configuration index, a set of time or frequency resources, etc.) and may be activated by a DCI message transmitted from the corresponding base station. Each SPS configuration 405 may be associated with a pool index value corresponding to the transmitting base station. For example, resource set 401 illustrated in FIG. 4A may be received at the same time as resource set 402 illustrated in FIG. 4B, but from a different base station. As such, SPS configurations 405 received in resource set 401 may be associated with a pool index value of 0, while SPS configurations 405 received in resource set 402 may be associated with a pool index value of 1.

The UE may receive SPS downlink messages on PDSCHs 415 that occur at regular intervals (e.g., in numbers of slots 425) in each SPS 405. In some examples, a UE may additionally receive a dynamic PDSCH 420 that is dynamically scheduled by PDCCH transmissions from a base station (e.g., via a DCI message). For example, as illustrated in FIG. 4A, the UE may receive a first SPS 405-a that may be configured with PDSCHs 415 that occur every second slot 425, a second SPS 405-b with PDSCHs 415 that occur every third slot 425, and a third SPS 405-c with PDSCHs 415 that occur every fourth slot 425, as well as a dynamic PDSCH 420-a received in slot 425-a and a dynamic PDSCH 420-b received in slot 425-b. Similarly, FIG. 4B illustrates an SPS 405-d configured with PDSCHs 415 that occur every third slot, an SPS 405-e configured with PDSCHs 415 that occur every sixth slot, and an SPS 405-f configured with PDSCHs 415 that occur every second slot, and a dynamic PDSCH 420-c received in slot 425-c. Thus, the UE may receive, in a single slot, multiple PDSCHs 415 from various SPS configurations 405 and associated with various pool indices in addition to one or more dynamic PDSCHs 420. While slots 425 are shown in FIGS. 4A-4C, it is to be understood that the SPSs 405 may include periodicities that occur at different length intervals (e.g., other TTIs, mini-slots, etc.).

In some examples, a dynamic PDSCH 420 received in the same slot as one or more SPS PDSCHs 415 may overlap in time with the SPS PDSCH(s) 415. For example, in slot 425-a, the UE may receive an SPS PDSCH 415 associated with SPS 405-a as well as a dynamic PDSCH 420-a, where both PDSCHs 415 and 420-a may overlap in time. The UE may determine to receive only the dynamic PDSCH 420-a and may cancel the PDSCH 415. The UE may cancel the PDSCH 415 provided that the DCI message scheduling the dynamic PDSCH 420-a ends a threshold number of symbols (e.g., 14 symbols) before the start of the SPS PDSCH 415.

In some cases, a dynamic PDSCH 420 associated with a first pool index value may overlap in time with an SPS PDSCH 415 associated with a second pool index value. For example, in slot 425-c, a PDSCH 415 of SPS 405-b may overlap in time with dynamic PDSCH 420-c. In this case, because PDSCH 415 and PDSCH 420-c correspond to different pool index values, the UE may receive both PDSCH 415 and PDSCH 420-c.

In some examples, the UE may receive, in a single slot, SPS PDSCHs 415 that overlap with one another in time and one or more dynamic PDSCHs 420 that overlap in time with one or more of the SPS PDSCHs 415. For example, slot 425-b includes a PDSCH 415-b that overlaps in time with a PDSCH 415 of SPS 405-a and a dynamic PDSCH 420-b. In such situations, the UE may first resolve overlapping SPS PDSCHs 415, as described in FIG. 3, and may subsequently address overlapping between SPS PDSCHs 415 and dynamic PDSCHs 420. In slot 425-b, for example, the UE may determine to receive SPS PDSCH 415 of SPS 405-a, and may discard SPS PDSCH 415 of SPS 405-b. The UE may then determine whether to receive one or both of PDSCH 415 of SPS 405-a and dynamic PDSCH 420-b. For instance, the UE may decode dynamic PDSCH 420-b and may drop PDSCH 415 of SPS 405-a.

FIG. 4C illustrates an example of a resource set 403 that includes PDSCHs 415 associated with SPS configurations 405-a through 405-f and dynamic PDSCHs 420, after the UE has resolved conflicting PDSCHs 415 and 420 that overlap in time. It is important to note that slot 425-c includes PDSCH 415 associated with SPS 405-b as well as dynamic PDSCH 420-c. Although PDSCH 415 of SPS 405-b and dynamic PDSCH 420-c overlap in time in slot 425-c, the UE may decode both, as each PDSCH is associated with a different pool index value.

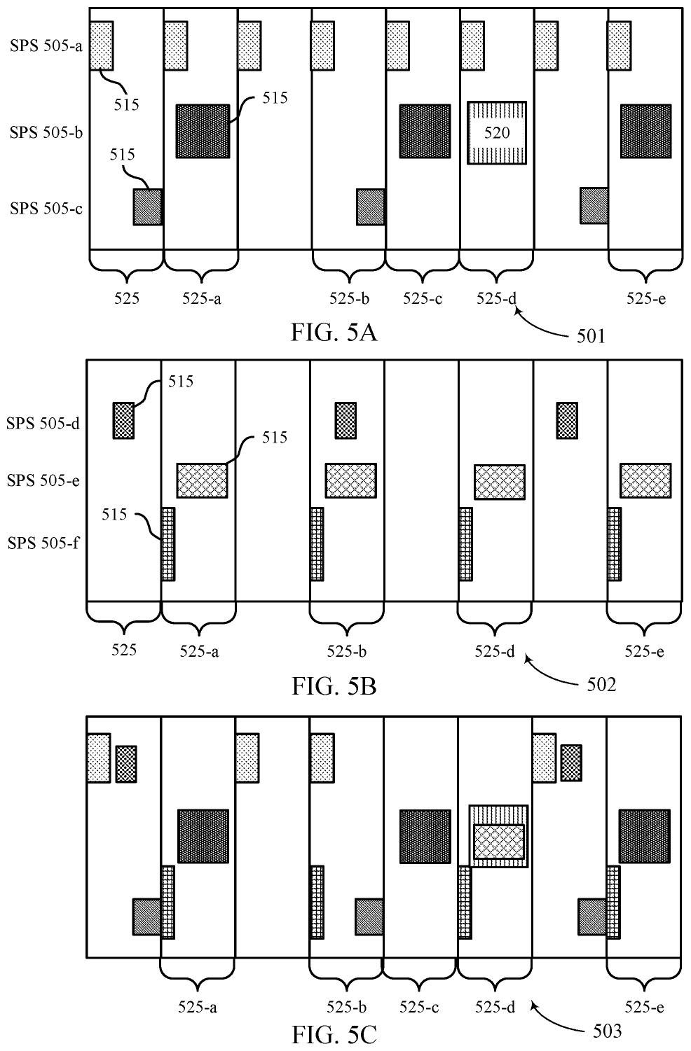

FIGS. 5A, 5B, and 5C illustrate examples of resource sets 501, 502, and 503 that support SPS reception configurations for multiple downlink shared channels in accordance with aspects of the present disclosure. In some examples, resource sets 501, 502, and 503 may implement aspects of wireless communication systems 100 and 200. For example, resource sets 501, 502, and 503 may be configured and transmitted by one or more base stations and may be received by a UE, which may be examples of base stations 105 and a UE 115 as described with reference to FIGS. 1 and 2, respectively.

As described herein, one or more base stations may transmit one or more SPS configurations 505 to a UE for a resource set 500. Each SPS configuration 505 may include various parameters (e.g., a periodicity, an SPS configuration index, a set of time or frequency resources, etc.) and may be activated by a DCI message transmitted from the corresponding base station. Each SPS configuration 505 may be associated with a pool index value corresponding to the transmitting base station. For example, resource set 501 illustrated in FIG. 5A may be received at the same time as resource set 502 illustrated in FIG. 5B, but from a different base station. As such, SPS configurations 505 received in resource set 501 may be associated with a pool index value of 0, while SPS configurations 505 received in resource set 502 may be associated with a pool index value of 1.

The UE may receive SPS downlink messages on PDSCHs 515 that occur at regular intervals (e.g., in numbers of slots 525) in each SPS 505. In some examples, a UE may additionally receive dynamic PDSCHs 520 that are dynamically scheduled by PDCCH transmissions from a base station (e.g., via a DCI message). For example, as illustrated in FIG. 5A, the UE may receive a first SPS 505-a that may be configured with PDSCHs 515 that occur in every slot 525, a second SPS 505-b with PDSCHs 515 that occur every third slot 525, and a third SPS 505-c with PDSCHs 515 that occur every fourth slot 525, as well as a dynamic PDSCH 520 received in slot 525-d. Similarly, FIG. 5B illustrates an SPS 505-d configured with PDSCHs 515 that occur every third slot, an SPS 505-e configured with PDSCHs 515 that occur every sixth slot, and an SPS 505-f configured with PDSCHs 515 that occur every second slot. Thus, the UE may receive, in a single slot, multiple PDSCHs 515 from various SPS configurations 505 and associated with various pool indices in addition to one or more dynamic PDSCHs 520. While slots 525 are shown in FIGS. 5A-5C, it is to be understood that the SPSs 505 may include periodicities that occur at different length intervals (e.g., other TTIs, mini-slots, etc.).

In some examples, the UE may receive PDSCHs 515 that overlap in time, frequency, or both in a single slot 525. For example, in slots 525-a, 525-c, and 525-e, PDSCH 515 of SPS 505-a overlaps with PDSCH 515 of SPS 505-b. Further, PDSCH of SPS 505-b in resource set 501 overlaps in both time and frequency with PDSCH 515 of SPS 505-e in resource set 502. Similarly, PDSCHs 515 of SPS 505-a overlap in frequency with PDSCHs 515 of SPS 505-d in every slot 525. In such situations, the UE may first resolve overlapping between PDSCHs associated with the same pool index value as described in FIG. 3, and may subsequently address overlapping between PDSCHs 515 associated with different pool index values. For example, the UE may determine which PDSCH 515 to decode between PDSCH 515 of SPS 505-a and PDSCH 515 of SPS 505-b. The UE may select PDSCH 515 of SPS 505-b because it may have a lower SPS configuration index than PDSCH 515 of SPS 505-a. PDSCH 515 of SPS 505-a may thus be dropped by the UE.

The UE may then resolve the time-frequency overlap between PDSCH 515 of SPS 505-b and PDSCH 515 of SPS 505-e. In some cases, the UE may first determine whether the DMRS symbols of the overlapping PDSCHs 515 are aligned or whether the DMRS ports of the overlapping PDSCHs 515 belong to different CDM groups. If the DMRS symbols are not aligned or the DMRS ports belong to the same CDM group, the UE may decode only one of the two overlapping PDSCHs 515. The UE may determine which PDSCH to decode according to a rule. For example, the UE may decode the PDSCH 515 associated with a pool index value of 0 (e.g., PDSCH 515 of SP 505-b) and may drop the other PDSCH 515 (e.g., PDSCH 515 of SPS 505-e. In some cases, the UE may instead determine to decode both PDSCHs 515 despite the overlap. For instance, PDSCH 515 of SPS 505-d in resource set 2 overlaps in frequency with PDSCH 515 of SPS 505-a in resource set 1, and the UE may determine to decode both PDSCHs 515.

In slot 525-b, PDSCH 515 of SPS 505-d overlaps in time with PDSCH 515 of SPS 505-e and in frequency with PDSCH 515 of SPS 505-a. In this case, the UE may resolve the time overlap among PDSCHs 515 associated with a first pool index (e.g., as described in FIG. 3). For example, the UE may first address overlap among PDSCHs 515 associated with a pool index of 1, and may determine to decode PDSCH 515 of SPS 505-d (e.g., because SPS 505-d has a lower SPS configuration index than SPS 505-e). The UE may then address the frequency overlap across pool indices (e.g., before addressing any overlap among PDSCHs 515 associated with the second pool index value), and may select between PDSCH 515 of SPS 505-d and PDSCH 515 of SPS 505-a. The selection may be made according to a rule. For instance, the UE may select PDSCH 515 of SPS 505-a rather than PDSCH 515 of SPS 505-d based on the associated pool index value. The UE may then resolve any remaining time overlap occurring between PDSCHs 515 of the second pool index value.

In some cases, the UE may receive a dynamic PDSCH 520 in the same slot as one or more SPS PDSCHs 515. The dynamic PDSCH 520 may overlap in time, frequency, or both with the SPS PDSCH(s) 515. For example, in slot 525-d, the UE may receive a PDSCH 515 of SPS 505-a, a PDSCH 515 of 505-e, and a PDSCH 515 of SPS 505-f, as well as a dynamic PDSCH 520. Dynamic PDSCH 520 may overlap in time with PDSCH 515 of SPS 505-a and may overlap in frequency with PDSCH 515 of SPS 505-e.

The UE may first address the time overlap between PDSCH 515 of SPS 505-a and dynamic PDSCH 520. The UE may, for example, determine to receive only the dynamic PDSCH 520 and may cancel the PDSCH 515. The UE may cancel the PDSCH 515 provided that the DCI message scheduling the dynamic PDSCH 520 ends a threshold number of symbols (e.g., 14 symbols) before the start of the SPS PDSCH 515. The UE may then resolve the frequency overlap between SPS PDSCH 515 of SPS 505-e and dynamic PDSCH 520. In some cases, the UE may first determine whether the DMRS symbols of the overlapping PDSCHs 515 are aligned or whether the DMRS ports of the overlapping PDSCHs 515 belong to different CDM groups. If the DMRS symbols are not aligned or the DMRS ports belong to the same CDM group, the UE may decode only one of the two overlapping PDSCHs 515. For example, the UE may determine to discard the SPS PDSCH 515 and may decode the dynamic PDSCH 520, if the DCI that scheduled the dynamic PDSCH 520 ends a threshold number of symbols before the SPS PDSCH 515 begins. However, in some other cases, the UE may decode both PDSCH 515 and dynamic PDSCH 520, given that the PDSCHs are associated with different pool index values.

FIG. 5C illustrates an example of a resource set 503 that includes PDSCHs 515 associated with SPS configurations 505-a through 505-f and dynamic PDSCH 520, after the UE has resolved conflicting PDSCHs 515 and 520 that overlap in time and frequency within slots. In slot 525-a, the UE has resolved a time overlap among PDSCHs 515 in resource set 501 and a frequency overlap among PDSCHs 515 across resource sets 501 and 502; thus, the UE receives PDSCH 515 of SPS 505-b and PDSCH 515 of SPS 505-f In slot 525-b, the UE has resolved a time overlap among PDSCHs 515 in resource set 502 as well as a frequency overlap among PDSCHs 515 across resource sets 501 and 502, and receives PDSCHs 515 of SPSs 505-a, 505-c, and 505-f. Similarly, in slots 525-c and 525-e, the UE receives PDSCH 515 of SPS 505-b after resolving time overlap among PDSCHs 515 of SPS 505-b and SPS 505-a. In these four slots, the UE resolves overlap and refrains from receiving PDSCHs 515 that overlap in time or frequency. Alternatively, in slot 525-d, the UE resolves a time and frequency overlap between dynamic PDSCH 520 in resource set 501 and PDSCH 515 of SPS 505-e in resource set 502. In this slot 525-d, though the PDSCHs overlap in time and frequency, the UE may still receive both PDSCHs (e.g., because each PDSCH is associated with a different pool index value).

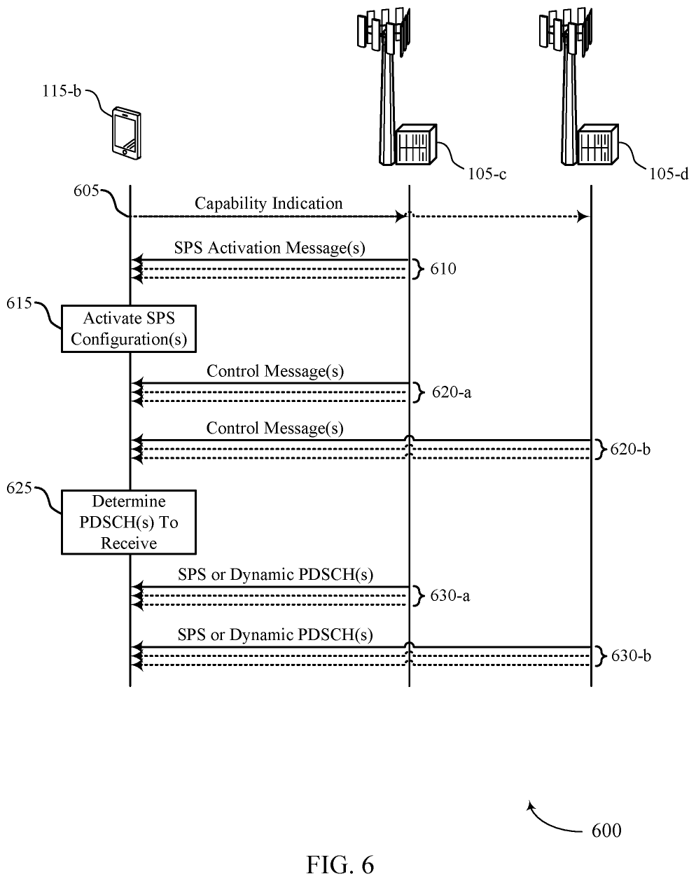

FIG. 6 illustrates an example of a process flow 600 that supports SPS reception configurations for multiple downlink shared channels in accordance with aspects of the present disclosure. In some examples, process flow 600 may implement aspects of wireless communications systems 100 or 200. The process flow 600 may include a UE 115-b, a base station 105-c, and a base station 105-d, which may be examples of the corresponding devices described herein. Alternative examples of the following may be implemented, where some processes are performed in a different order than described or are not performed at all. In some cases, processes may include additional features not mentioned below, or further processes or operations may be added.

At 605, UE 115-b may optionally transmit a capability indication to one or both of base station 105-c and base station 105-d. The capability indication may indicate a number of PDSCH messages that the 115-b is capable of receiving at a given time. For instance, the capability indication may indicate that the UE 115-b is capable of receiving 3, 4, 7, etc. PDSCH messages at a given time. In some cases, the capability indication may be pool index specific such that the UE 115-b indicates a number of PDSCH messages capable of being received for a first pool index (e.g., pool index of 1) and a second number of PDSCH messages capable of being received for a second pool index (e.g., pool index of 0). Additionally or alternatively, the capability indication may indicate the total number of PDSCH messages capable of being received by the UE 115-b at a given time for all pool indices.

At 610, base station 105-c may transmit one or more SPS activation messages. An SPS activation message may be included in DCI carried by a PDCCH for the UE 115-b. Each SPS activation message(s) may trigger activation of an SPS configuration for the UE 115-b of a set of SPS configurations for the UE 115-b. Each triggered SPS configuration may be associated with an SPS configuration index and a given pool index corresponding to the base station (e.g., base station 105-c) performing transmission of the PDSCH(s) associated with the SPS configuration.

At 615, after receiving one or more SPS activation messages, UE 115-b may activate one or more SPS configurations corresponding to the received SPS activation message(s). Activating a given SPS configuration may be based on an SPS configuration index associated with the SPS configuration and may indicate a set of time-frequency resources for a set of SPS PDSCH messages to be transmitted by the base station 105-c to the UE 115-b.

At 620, one or more of base stations 105-c and 105-d may transmit one or more control message(s) to the UE 115-b. For example, at 620-a, base station 105-c may transmit one or more control messages to the UE 115-b and optionally at 620-b, base station 105-d may transmit one or more control messages to the UE 115-b. Each control message may indicate one or more PDSCH transmissions for the UE 115-b and may be respectively associated with a given pool index depending on which base station transmitted the control message. For instance, a control message may be a DCI that dynamically schedules a PDSCH for the UE 115-b from one of base station 105-c or base station 105-d. Alternatively, the control message may be an SPS activation message that triggers activation of an SPS configuration for the UE 115-b from one of base station 105-c or base station 105-d. In such cases, after receiving the one or more control messages at 620, the UE 115-b may identify multiple PDSCH(s) for the UE 115-b and corresponding time-frequency resources for each of the multiple PDSCH(s).

At 625, of the multiple PDSCH(s) associated with the SPS configuration(s) activated at 615 and one or more control messages at 620, UE 115-b may determine which of the PDSCH(s) to receive. In some example, the UE 115-b may determine to receive an SPS PDSCH or a dynamic PDSCH based on a pool index value or a priority level associated with the SPS PDSCH or dynamic PDSCH, as described herein. Additionally or alternatively, the UE 115-b may determine to receive an SPS PDSCH or dynamic PDSCH based on whether the SPS PDSCH or dynamic PDSCH overlaps in time or frequency with another SPS PDSCH or dynamic PDSCH associated with the same or different pool index, as described herein. In some cases, the UE 115-b may refrain from receiving one or more PDSCH(s) or may receive all PDSCH(s) for the UE 115-b. Further, the UE 115-b may be capable of receiving a number of PDSCH(s) as indicated by the capability indication transmitted at 605, and may receive the number of PDSCH(s) capable of being received by the UE 115-b.

At 630, base station 105-c and base station 105-d may transmit, and the UE 115-b may receive one or more PDSCH(s) based on the determination at 625, as described herein. For example, at 630-a, UE 115-b may receive an SPS PDSCH, a dynamic PDSCH, or both from base station 105-c. At 630-b, UE 115-b may receive an SPS PDSCH, a dynamic PDSCH, or both from base station 105-d.

Implementing one or aspects of the process flow 600 may allow for reliable uplink transmissions from a UE 115-b to a base station 105-c in the event of a decreased beam reliability.

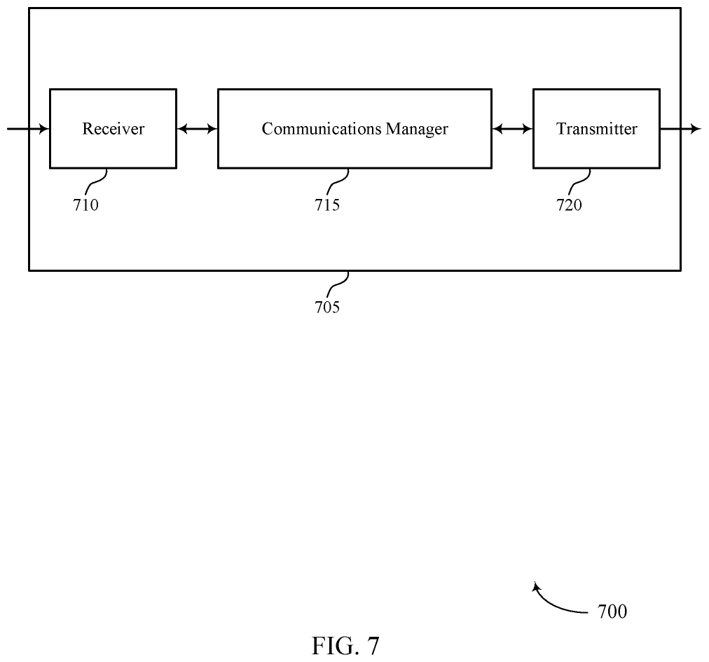

FIG. 7 shows a block diagram 700 of a device 705 that supports SPS reception configurations for multiple downlink shared channels in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

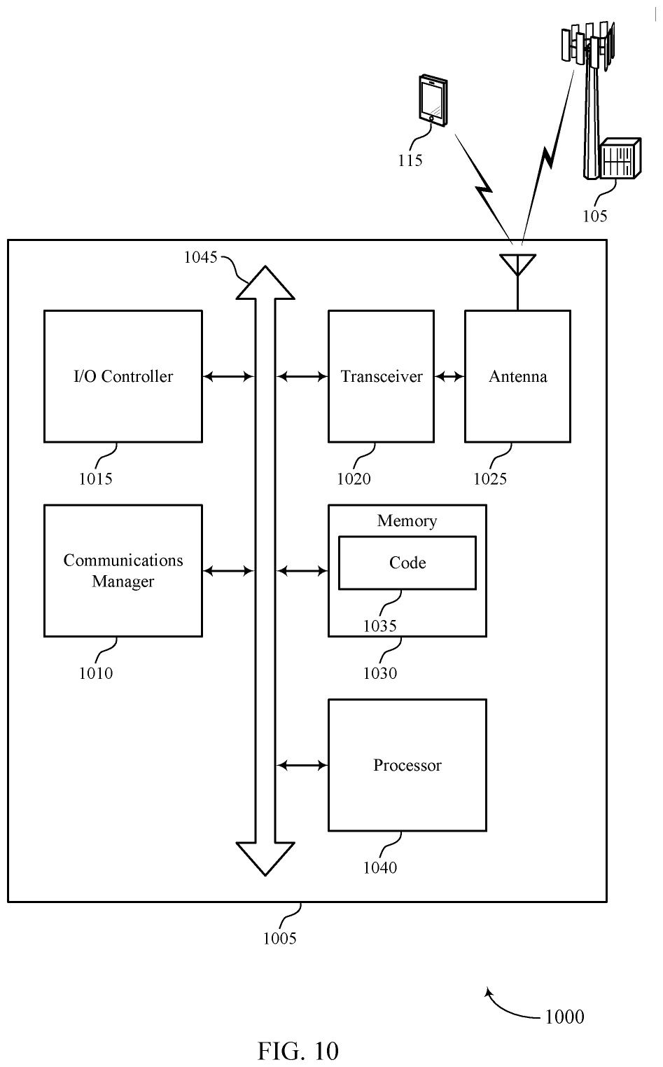

The receiver 710 may receive information such as packets, user data, or control information associated with various information channels (e.g., control channels, data channels, and information related to SPS reception configurations for multiple downlink shared channels, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may activate a set of SPS configurations for a set of downlink shared channels for the UE, the set of downlink shared channels associated with a first pool index, receive a control message that indicates time-frequency resources for a second downlink shared channel for the UE, the second downlink shared channel associated with a second pool index, determine whether to receive at least one of the set of downlink shared channels or the second downlink shared channel based on a time overlap of the set of downlink shared channels and the second downlink shared channel, and receive the at least one of the set of downlink shared channels, the second downlink shared channel, or both based on the determining. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

In some examples, the communications manager 715 may be implemented as an integrated circuit or chipset for a mobile device modem, and the receiver 710 and transmitter 720 may be implemented as analog components (e.g., amplifiers, filters, antennas) coupled with the mobile device modem to enable wireless transmission and reception over one or more bands.

The communications manager 715 as described herein may be implemented to realize one or more potential advantages. One implementation may allow the device 705 to resolve time overlaps among downlink shared channels. The communications manager 715 may use the techniques described herein to determine which, if any, of the overlapping downlink shared channels to receive. Based on the techniques, the device 705 may avoid losing or unsuccessfully decoding overlapping transmissions.

As such, the device 705 may receive downlink shared channels with increased reliability and, accordingly, may communicate over the channel with a greater likelihood of successful communications. In some examples, based on a greater likelihood of successful communications, the device 705 may more efficiently power a processor or one or more processing units associated with transmitting and receiving communications, which may enable the device to save power and increase battery life.

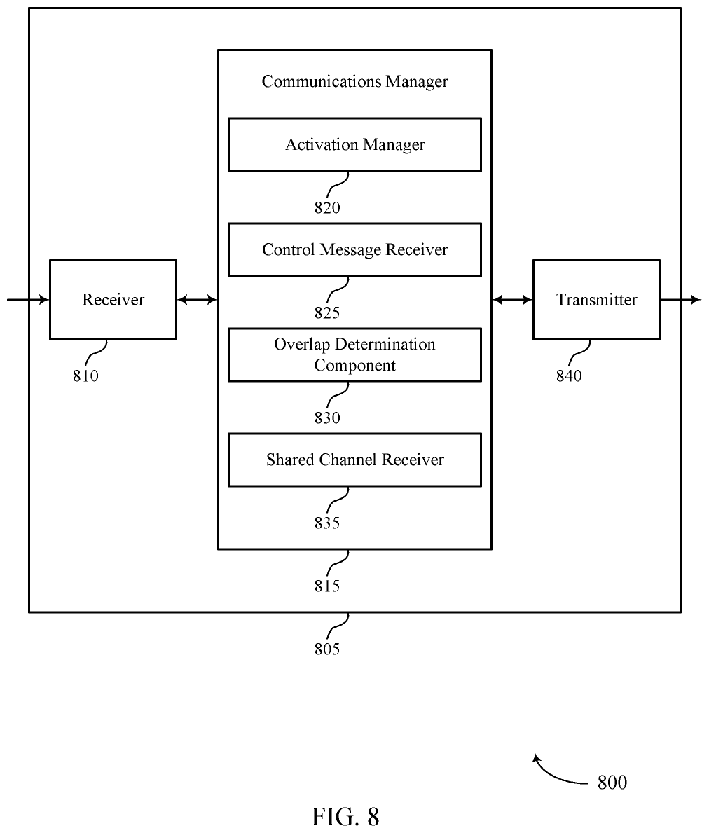

FIG. 8 shows a block diagram 800 of a device 805 that supports SPS reception configurations for multiple downlink shared channels in accordance with aspects of the present disclosure. The device 805 may be an example of aspects of a device 705, or a UE 115 as described herein. The device 805 may include a receiver 810, a communications manager 815, and a transmitter 840. The device 805 may also include a processor. Each of these components may be in communication with one another (e.g., via one or more buses).

The receiver 810 may receive information such as packets, user data, or control information associated with various information channels (e.g., control channels, data channels, and information related to SPS reception configurations for multiple downlink shared channels, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include an activation manager 820, a control message receiver 825, an overlap determination component 830, and a shared channel receiver 835. The communications manager 815 may be an example of aspects of the communications manager 1010 described herein.

The activation manager 820 may activate a set of SPS configurations for a set of downlink shared channels for the UE, the set of downlink shared channels associated with a first pool index.

The control message receiver 825 may receive a control message that indicates time-frequency resources for a second downlink shared channel for the UE, the second downlink shared channel associated with a second pool index.

The overlap determination component 830 may determine whether to receive at least one of the set of downlink shared channels or the second downlink shared channel based on a time overlap of the set of downlink shared channels and the second downlink shared channel.

The shared channel receiver 835 may receive the at least one of the set of downlink shared channels, the second downlink shared channel, or both based on the determining.

The transmitter 840 may transmit signals generated by other components of the device 805. In some examples, the transmitter 840 may be collocated with a receiver 810 in a transceiver module. For example, the transmitter 840 may be an example of aspects of the transceiver 1020 described with reference to FIG. 10. The transmitter 840 may utilize a single antenna or a set of antennas.

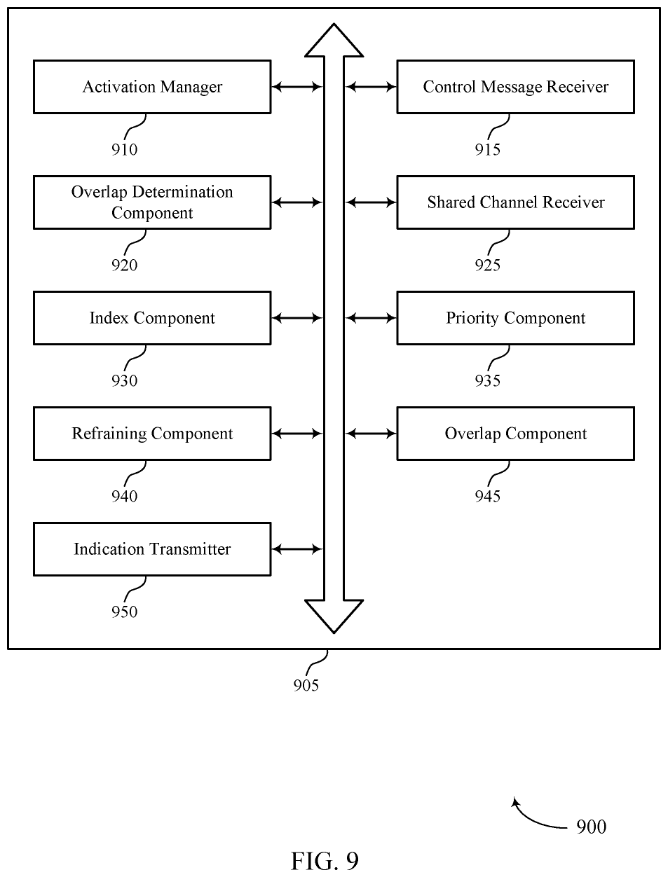

FIG. 9 shows a block diagram 900 of a communications manager 905 that supports SPS reception configurations for multiple downlink shared channels in accordance with aspects of the present disclosure. The communications manager 905 may be an example of aspects of a communications manager 715, a communications manager 815, or a communications manager 1010 described herein. The communications manager 905 may include an activation manager 910, a control message receiver 915, an overlap determination component 920, a shared channel receiver 925, an index component 930, a priority component 935, a refraining component 940, an overlap component 945, and an indication transmitter 950. Each of these modules may communicate, directly or indirectly, with one another (e.g., via one or more buses).

The activation manager 910 may activate a set of SPS configurations for a set of downlink shared channels for the UE, the set of downlink shared channels associated with a first pool index.

In some examples, the activation manager 910 may activate a second set of SPS configurations for a second set of downlink shared channels associated with the second pool index and including the second downlink shared channel based on the control message and one or more additional control messages.

In some examples, the activation manager 910 may activate a second set of SPS configurations for a second set of downlink shared channels associated with the second pool index and including the second downlink shared channel based on the control message and one or more additional control messages.

The control message receiver 915 may receive a control message that indicates time-frequency resources for a second downlink shared channel for the UE, the second downlink shared channel associated with a second pool index.

The overlap determination component 920 may determine whether to receive at least one of the set of downlink shared channels or the second downlink shared channel based on a time overlap of the set of downlink shared channels and the second downlink shared channel.

The shared channel receiver 925 may receive the at least one of the set of downlink shared channels, the second downlink shared channel, or both based on the determining. In some examples, the shared channel receiver 925 may receive the second downlink shared channel based on the second downlink shared channel being dynamically scheduled by the control message.

In some examples, the shared channel receiver 925 may receive a downlink shared channel of the set of downlink shared channels or the second downlink shared channel according to a set of rules based on the downlink shared channel and the second downlink shared channel at least partially overlapping in both time and frequency.

In some examples, the shared channel receiver 925 may receive both of a downlink shared channel of the set of downlink shared channels and the second downlink shared channel based on the downlink shared channel and the second downlink shared channel at least partially overlapping in both time and frequency, where the first pool index is different from the second pool index.

In some examples, the shared channel receiver 925 may receive both of a downlink shared channel of the set of downlink shared channels and the second downlink shared channel based on the first pool index being different from the second pool index. In some examples, the shared channel receiver 925 may receive the second downlink shared channel based on the second downlink shared channel at least partially overlapping in both time and frequency with at least one of the set of downlink shared channels.

In some examples, the shared channel receiver 925 may receive at least one of the set of downlink shared channels and the second downlink shared channel based on the second downlink shared channel at least partially overlapping in both time and frequency with the at least one of the set of downlink shared channels. In some examples, the shared channel receiver 925 may receive at least one of the set of downlink shared channels and the second downlink shared channel independent of an alignment between DMRS symbols of the downlink shared channel and DMRS symbols of the second downlink shared channel and independent of one or more DMRS ports of the downlink shared channel and one or more DMRS ports of the second downlink shared channel belonging to a same DMRS CDM group. In some examples, the shared channel receiver 925 may determine to receive one or more of the set of downlink shared channels or the second downlink shared channel based on the number of shared channels capable of being received by the UE. In some examples, the second downlink shared channel is associated with a semi-persistently scheduled downlink shared channel.

In some cases, the set of rules indicates that only downlink shared channels associated with a given pool index are to be received by the UE based on DMRS symbols of the downlink shared channel and the second downlink shared channel being misaligned.

In some cases, the set of rules indicates that only downlink shared channels associated with a given pool index are to be received by the UE based on one or more DMRS ports of the downlink shared channel and one or more DMRS ports of the second downlink shared channel belonging to a same DMRS CDM group.

The index component 930 may determine to receive a first downlink shared channel over a third downlink shared channel of the set of downlink shared channels based on a SPS configuration index associated with the first downlink shared channel being lower than a SPS configuration index associated with the third downlink shared channel.

In some examples, the index component 930 may determine to receive the second downlink shared channel over a third downlink shared channel of the second set of downlink shared channels based on an SPS configuration index associated with the second downlink shared channel being lower than an SPS configuration index associated with the third downlink shared channel.

In some examples, the index component 930 may determine to receive a first downlink shared channel over a third downlink shared channel of the set of downlink shared channels based on an SPS configuration index associated with the first downlink shared channel being lower than an SPS configuration index associated with the third downlink shared channel.

The priority component 935 may determine to receive a first downlink shared channel over a third downlink shared channel of the set of downlink shared channels based on a priority of the first downlink shared channel being higher than a priority of the third downlink shared channel. In some examples, the priority component 935 may determine to receive the second downlink shared channel over a third downlink shared channel of the second set of downlink shared channels based on a priority of the second downlink shared channel being higher than a priority of the third downlink shared channel.

The refraining component 940 may determine to refrain from receiving one or more of the set of downlink shared channels based on the second downlink shared channel at least partially overlapping in time with the one or more of the set of downlink shared channels, where the second pool index is the same as the first pool index.

In some examples, the refraining component 940 may determine to refrain from receiving one or more of the second set of downlink shared channels based on the one or more of the second set of downlink shared channels at least partially overlapping in time or frequency with the first downlink shared channel.

In some examples, the DMRS symbols of the first downlink shared channel and the one or more of the second set of downlink shared channels are misaligned. In some examples, one or more DMRS ports of the first downlink shared channel and one or more DMRS ports of the one or more of the second set of downlink shared channels belong to a same DMRS CDM group.

In some examples, the refraining component 940 may refrain from receiving the at least one of the set of downlink shared channels.

In some examples, the DMRS symbols of the downlink shared channel and the second downlink shared channel are misaligned. In some examples, one or more DMRS ports of the downlink shared channel and one or more DMRS ports of the second downlink shared channel belong to a same DMRS CDM group.

In some cases, a start symbol of the one or more of the set of downlink shared channels is a threshold number of symbols apart from an end of the control message. In some cases, a start symbol of the at least one downlink shared channel is a threshold number of symbols apart from an end of the control message.

The overlap component 945 may determine to receive a fourth downlink shared channel over a fifth downlink shared channel of remaining downlink shared channels of the second set of downlink shared channels based on a SPS configuration index associated with the fourth downlink shared channel being lower than a SPS configuration index associated with the fifth downlink shared channel.

The indication transmitter 950 may transmit an indication of a number of shared channels capable of being received by the UE. In some cases, the indication includes a first number of shared channels of the first pool index capable of being received by the UE. In some cases, the indication includes a second number of shared channels of the second pool index capable of being received by the UE.

FIG. 10 shows a diagram of a system 1000 including a device 1005 that supports SPS reception configurations for multiple downlink shared channels in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may activate a set of SPS configurations for a set of downlink shared channels for the UE, the set of downlink shared channels associated with a first pool index, receive a control message that indicates time-frequency resources for a second downlink shared channel for the UE, the second downlink shared channel associated with a second pool index, determine whether to receive at least one of the set of downlink shared channels or the second downlink shared channel based on a time overlap of the set of downlink shared channels and the second downlink shared channel, and receive the at least one of the set of downlink shared channels, the second downlink shared channel, or both based on the determining.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM and ROM. The memory 1030 may store computer-readable, computer-executable code 1035 including instructions that, when executed, cause the processor to perform various functions described herein. In some cases, the memory 1030 may contain, among other things, a BIOS which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting SPS reception configurations for multiple downlink shared channels).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

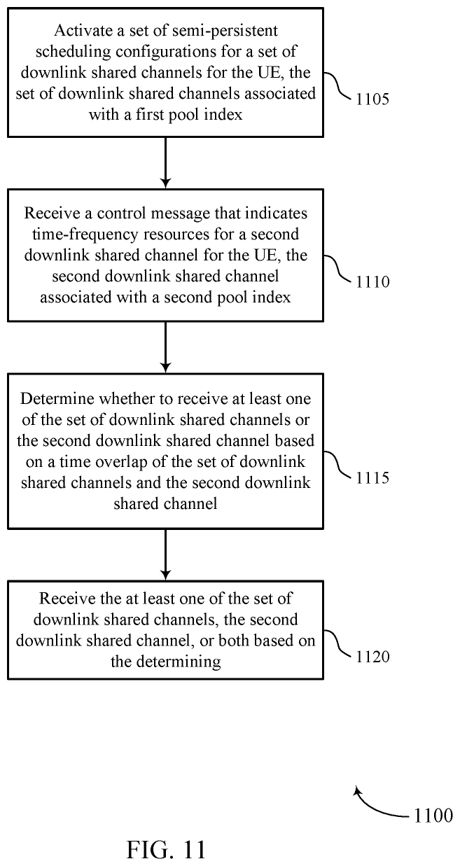

FIG. 11 shows a flowchart illustrating a method 1100 that supports SPS reception configurations for multiple downlink shared channels in accordance with aspects of the present disclosure. The operations of method 1100 may be implemented by a UE 115 or its components as described herein. For example, the operations of method 1100 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1105, the UE may activate a set of SPS configurations for a set of downlink shared channels for the UE, the set of downlink shared channels associated with a first pool index. The operations of 1105 may be performed according to the methods described herein. In some examples, aspects of the operations of 1105 may be performed by an activation manager as described with reference to FIGS. 7 through 10.

At 1110, the UE may receive a control message that indicates time-frequency resources for a second downlink shared channel for the UE, the second downlink shared channel associated with a second pool index. The operations of 1110 may be performed according to the methods described herein. In some examples, aspects of the operations of 1110 may be performed by a control message receiver as described with reference to FIGS. 7 through 10.

At 1115, the UE may determine whether to receive at least one of the set of downlink shared channels or the second downlink shared channel based on a time overlap of the set of downlink shared channels and the second downlink shared channel. The operations of 1115 may be performed according to the methods described herein. In some examples, aspects of the operations of 1115 may be performed by an overlap determination component as described with reference to FIGS. 7 through 10.

At 1120, the UE may receive the at least one of the set of downlink shared channels, the second downlink shared channel, or both based on the determining. The operations of 1120 may be performed according to the methods described herein. In some examples, aspects of the operations of 1120 may be performed by a shared channel receiver as described with reference to FIGS. 7 through 10.

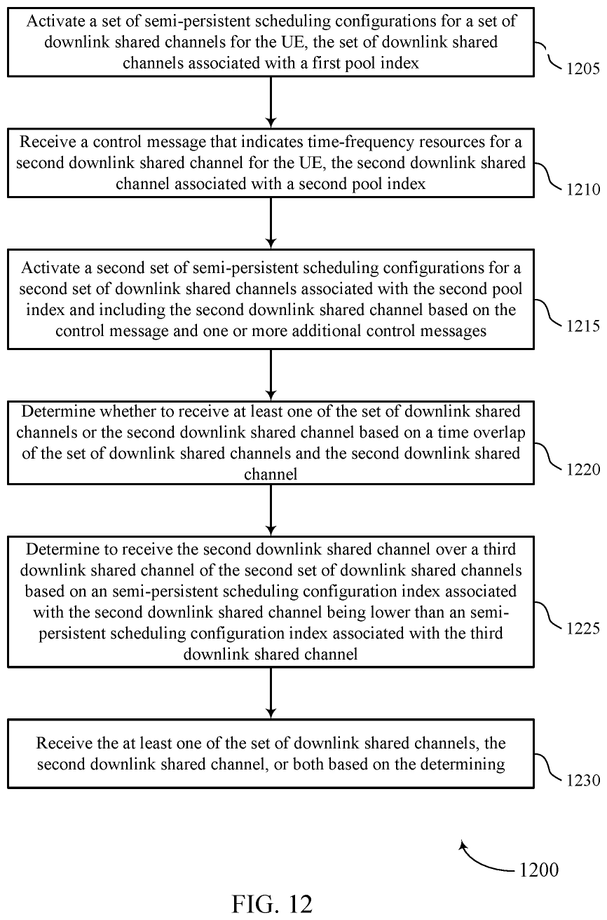

FIG. 12 shows a flowchart illustrating a method 1200 that supports SPS reception configurations for multiple downlink shared channels in accordance with aspects of the present disclosure. The operations of method 1200 may be implemented by a UE 115 or its components as described herein. For example, the operations of method 1200 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1205, the UE may activate a set of SPS configurations for a set of downlink shared channels for the UE, the set of downlink shared channels associated with a first pool index. The operations of 1205 may be performed according to the methods described herein. In some examples, aspects of the operations of 1205 may be performed by an activation manager as described with reference to FIGS. 7 through 10.

At 1210, the UE may receive a control message that indicates time-frequency resources for a second downlink shared channel for the UE, the second downlink shared channel associated with a second pool index. The operations of 1210 may be performed according to the methods described herein. In some examples, aspects of the operations of 1210 may be performed by a control message receiver as described with reference to FIGS. 7 through 10.

At 1215, the UE may activate a second set of SPS configurations for a second set of downlink shared channels associated with the second pool index and including the second downlink shared channel based on the control message and one or more additional control messages. The operations of 1215 may be performed according to the methods described herein. In some examples, aspects of the operations of 1215 may be performed by an activation manager as described with reference to FIGS. 7 through 10.

At 1220, the UE may determine whether to receive at least one of the set of downlink shared channels or the second downlink shared channel based on a time overlap of the set of downlink shared channels and the second downlink shared channel. The operations of 1220 may be performed according to the methods described herein. In some examples, aspects of the operations of 1220 may be performed by an overlap determination component as described with reference to FIGS. 7 through 10.

At 1225, the UE may determine to receive the second downlink shared channel over a third downlink shared channel of the second set of downlink shared channels based on an SPS configuration index associated with the second downlink shared channel being lower than an SPS configuration index associated with the third downlink shared channel. The operations of 1225 may be performed according to the methods described herein. In some examples, aspects of the operations of 1225 may be performed by an index component as described with reference to FIGS. 7 through 10.

At 1230, the UE may receive the at least one of the set of downlink shared channels, the second downlink shared channel, or both based on the determining. The operations of 1230 may be performed according to the methods described herein. In some examples, aspects of the operations of 1230 may be performed by a shared channel receiver as described with reference to FIGS. 7 through 10.

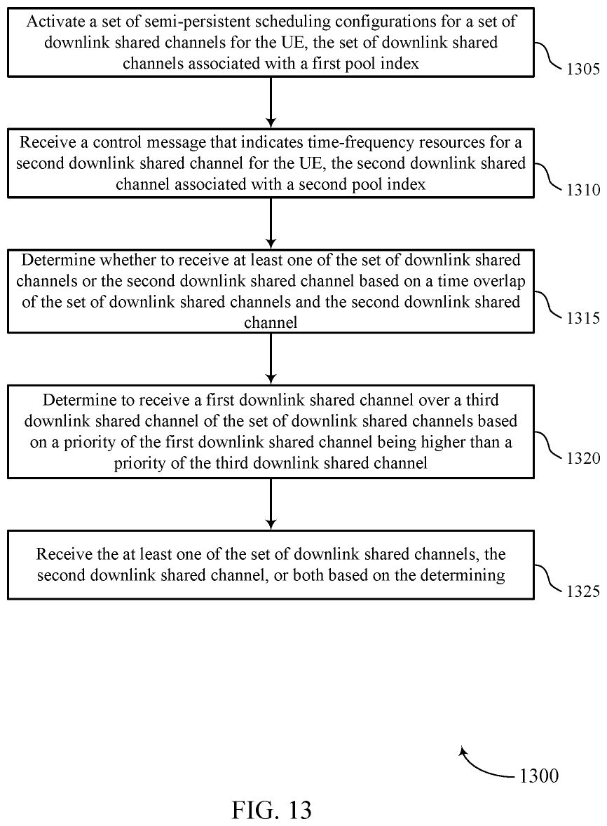

FIG. 13 shows a flowchart illustrating a method 1300 that supports SPS reception configurations for multiple downlink shared channels in accordance with aspects of the present disclosure. The operations of method 1300 may be implemented by a UE 115 or its components as described herein. For example, the operations of method 1300 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1305, the UE may activate a set of SPS configurations for a set of downlink shared channels for the UE, the set of downlink shared channels associated with a first pool index. The operations of 1305 may be performed according to the methods described herein. In some examples, aspects of the operations of 1305 may be performed by an activation manager as described with reference to FIGS. 7 through 10.

At 1310, the UE may receive a control message that indicates time-frequency resources for a second downlink shared channel for the UE, the second downlink shared channel associated with a second pool index. The operations of 1310 may be performed according to the methods described herein. In some examples, aspects of the operations of 1310 may be performed by a control message receiver as described with reference to FIGS. 7 through 10.

At 1315, the UE may determine whether to receive at least one of the set of downlink shared channels or the second downlink shared channel based on a time overlap of the set of downlink shared channels and the second downlink shared channel. The operations of 1315 may be performed according to the methods described herein. In some examples, aspects of the operations of 1315 may be performed by an overlap determination component as described with reference to FIGS. 7 through 10.

At 1320, the UE may determine to receive a first downlink shared channel over a third downlink shared channel of the set of downlink shared channels based on a priority of the first downlink shared channel being higher than a priority of the third downlink shared channel. The operations of 1320 may be performed according to the methods described herein. In some examples, aspects of the operations of 1320 may be performed by a priority component as described with reference to FIGS. 7 through 10.

At 1325, the UE may receive the at least one of the set of downlink shared channels, the second downlink shared channel, or both based on the determining. The operations of 1325 may be performed according to the methods described herein. In some examples, aspects of the operations of 1325 may be performed by a shared channel receiver as described with reference to FIGS. 7 through 10.

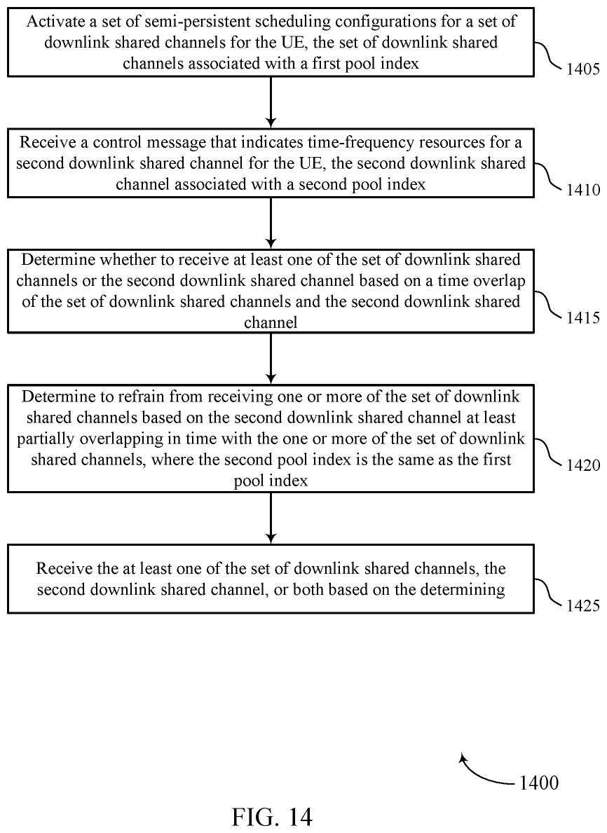

FIG. 14 shows a flowchart illustrating a method 1400 that supports SPS reception configurations for multiple downlink shared channels in accordance with aspects of the present disclosure. The operations of method 1400 may be implemented by a UE 115 or its components as described herein. For example, the operations of method 1400 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1405, the UE may activate a set of SPS configurations for a set of downlink shared channels for the UE, the set of downlink shared channels associated with a first pool index. The operations of 1405 may be performed according to the methods described herein. In some examples, aspects of the operations of 1405 may be performed by an activation manager as described with reference to FIGS. 7 through 10.

At 1410, the UE may receive a control message that indicates time-frequency resources for a second downlink shared channel for the UE, the second downlink shared channel associated with a second pool index. The operations of 1410 may be performed according to the methods described herein. In some examples, aspects of the operations of 1410 may be performed by a control message receiver as described with reference to FIGS. 7 through 10.

At 1415, the UE may determine whether to receive at least one of the set of downlink shared channels or the second downlink shared channel based on a time overlap of the set of downlink shared channels and the second downlink shared channel. The operations of 1415 may be performed according to the methods described herein. In some examples, aspects of the operations of 1415 may be performed by an overlap determination component as described with reference to FIGS. 7 through 10.

At 1420, the UE may determine to refrain from receiving one or more of the set of downlink shared channels based on the second downlink shared channel at least partially overlapping in time with the one or more of the set of downlink shared channels, where the second pool index is the same as the first pool index. The operations of 1420 may be performed according to the methods described herein. In some examples, aspects of the operations of 1420 may be performed by a refraining component as described with reference to FIGS. 7 through 10.

At 1425, the UE may receive the at least one of the set of downlink shared channels, the second downlink shared channel, or both based on the determining. The operations of 1425 may be performed according to the methods described herein. In some examples, aspects of the operations of 1425 may be performed by a shared channel receiver as described with reference to FIGS. 7 through 10.

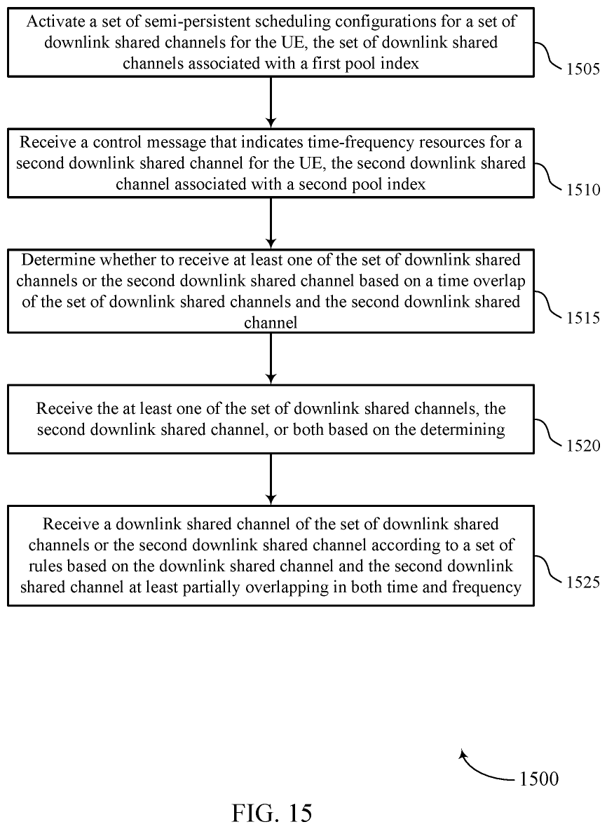

FIG. 15 shows a flowchart illustrating a method 1500 that supports SPS reception configurations for multiple downlink shared channels in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1505, the UE may activate a set of SPS configurations for a set of downlink shared channels for the UE, the set of downlink shared channels associated with a first pool index. The operations of 1505 may be performed according to the methods described herein. In some examples, aspects of the operations of 1505 may be performed by an activation manager as described with reference to FIGS. 7 through 10.

At 1510, the UE may receive a control message that indicates time-frequency resources for a second downlink shared channel for the UE, the second downlink shared channel associated with a second pool index. The operations of 1510 may be performed according to the methods described herein. In some examples, aspects of the operations of 1510 may be performed by a control message receiver as described with reference to FIGS. 7 through 10.

At 1515, the UE may determine whether to receive at least one of the set of downlink shared channels or the second downlink shared channel based on a time overlap of the set of downlink shared channels and the second downlink shared channel. The operations of 1515 may be performed according to the methods described herein. In some examples, aspects of the operations of 1515 may be performed by an overlap determination component as described with reference to FIGS. 7 through 10.

At 1520, the UE may receive the at least one of the set of downlink shared channels, the second downlink shared channel, or both based on the determining. The operations of 1520 may be performed according to the methods described herein. In some examples, aspects of the operations of 1520 may be performed by a shared channel receiver as described with reference to FIGS. 7 through 10.

At 1525, the UE may receive a downlink shared channel of the set of downlink shared channels or the second downlink shared channel according to a set of rules based on the downlink shared channel and the second downlink shared channel at least partially overlapping in both time and frequency. The operations of 1525 may be performed according to the methods described herein. In some examples, aspects of the operations of 1525 may be performed by a shared channel receiver as described with reference to FIGS. 7 through 10.

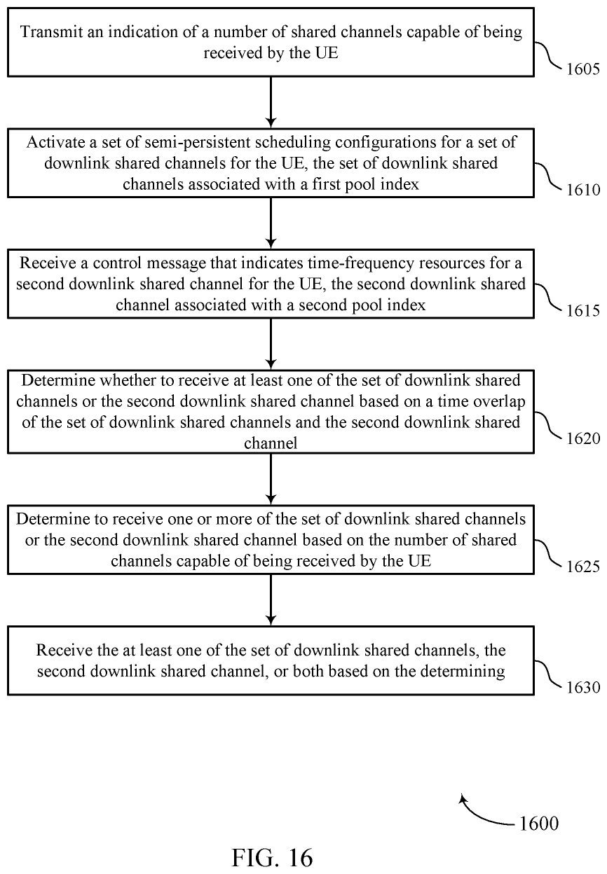

FIG. 16 shows a flowchart illustrating a method 1600 that supports SPS reception configurations for multiple downlink shared channels in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1605, the UE may transmit an indication of a number of shared channels capable of being received by the UE. The operations of 1605 may be performed according to the methods described herein. In some examples, aspects of the operations of 1605 may be performed by an indication transmitter as described with reference to FIGS. 7 through 10.

At 1610, the UE may activate a set of SPS configurations for a set of downlink shared channels for the UE, the set of downlink shared channels associated with a first pool index. The operations of 1610 may be performed according to the methods described herein. In some examples, aspects of the operations of 1610 may be performed by an activation manager as described with reference to FIGS. 7 through 10.

At 1615, the UE may receive a control message that indicates time-frequency resources for a second downlink shared channel for the UE, the second downlink shared channel associated with a second pool index. The operations of 1615 may be performed according to the methods described herein. In some examples, aspects of the operations of 1615 may be performed by a control message receiver as described with reference to FIGS. 7 through 10.

At 1620, the UE may determine whether to receive at least one of the set of downlink shared channels or the second downlink shared channel based on a time overlap of the set of downlink shared channels and the second downlink shared channel. The operations of 1620 may be performed according to the methods described herein. In some examples, aspects of the operations of 1620 may be performed by an overlap determination component as described with reference to FIGS. 7 through 10.

At 1625, the UE may determine to receive one or more of the set of downlink shared channels or the second downlink shared channel based on the number of shared channels capable of being received by the UE. The operations of 1625 may be performed according to the methods described herein. In some examples, aspects of the operations of 1625 may be performed by a shared channel receiver as described with reference to FIGS. 7 through 10.

At 1630, the UE may receive the at least one of the set of downlink shared channels, the second downlink shared channel, or both based on the determining. The operations of 1630 may be performed according to the methods described herein. In some examples, aspects of the operations of 1630 may be performed by a shared channel receiver as described with reference to FIGS. 7 through 10.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a UE, comprising: activating a set of SPS configurations for a set of downlink shared channels for the UE, the set of downlink shared channels associated with a first pool index; receiving a control message that indicates time-frequency resources for a second downlink shared channel for the UE, the second downlink shared channel associated with a second pool index; determining whether to receive at least one of the set of downlink shared channels or the second downlink shared channel based at least in part on a time overlap of the set of downlink shared channels and the second downlink shared channel; and receiving the at least one of the set of downlink shared channels, the second downlink shared channel, or both based at least in part on the determining.

Aspect 2: The method of aspect 1, further comprising: determining to receive a first downlink shared channel of the set of downlink shared channels over a third downlink shared channel of the set of downlink shared channels based at least in part on an SPS configuration index associated with the first downlink shared channel being lower than an SPS configuration index associated with the third downlink shared channel.

Aspect 3: The method of any of aspects 1 through 2, further comprising: activating a second set of SPS configurations for a second set of downlink shared channels associated with the second pool index and including the second downlink shared channel based at least in part on the control message and one or more additional control messages; and determining to receive the second downlink shared channel over a third downlink shared channel of the second set of downlink shared channels based at least in part on an SPS configuration index associated with the second downlink shared channel being lower than an SPS configuration index associated with the third downlink shared channel.

Aspect 4: The method of any of aspects 1 through 3, further comprising: determining to receive a first downlink shared channel over a third downlink shared channel of the set of downlink shared channels based at least in part on a priority of the first downlink shared channel being higher than a priority of the third downlink shared channel.

Aspect 5: The method of any of aspects 1 through 4, further comprising: activating a second set of SPS configurations for a second set of downlink shared channels associated with the second pool index and including the second downlink shared channel based at least in part on the control message and one or more additional control messages; and determining to receive the second downlink shared channel over a third downlink shared channel of the second set of downlink shared channels based at least in part on a priority of the second downlink shared channel being higher than a priority of the third downlink shared channel.

Aspect 6: The method of any of aspects 1 through 5, further comprising: receiving both of a downlink shared channel of the set of downlink shared channels and the second downlink shared channel based at least in part on the second downlink shared channel being dynamically scheduled by the control message and the first pool index being different from the second pool index, wherein the downlink shared channel and the second downlink shared channel overlap in time.

Aspect 7: The method of any of aspects 1 through 6, further comprising: determining to refrain from receiving one or more of the set of downlink shared channels based at least in part on the second downlink shared channel at least partially overlapping in time with the one or more of the set of downlink shared channels, wherein the second pool index is the same as the first pool index.

Aspect 8: The method of aspect 7, wherein a start symbol of the one or more of the set of downlink shared channels is a threshold number of symbols apart from an end of the control message.

Aspect 9: The method of any of aspects 1 through 8, further comprising: receiving a downlink shared channel of the set of downlink shared channels or the second downlink shared channel according to a set of rules based at least in part on the downlink shared channel and the second downlink shared channel at least partially overlapping in both time and frequency.

Aspect 10: The method of aspect 9, wherein the set of rules indicates that only downlink shared channels associated with a given pool index are to be received by the UE based at least in part on DMRS symbols of the downlink shared channel and the second downlink shared channel being misaligned.

Aspect 11: The method of any of aspects 9 through 10, wherein the set of rules indicates that only downlink shared channels associated with a given pool index are to be received by the UE based at least in part on one or more DMRS ports of the downlink shared channel and one or more DMRS ports of the second downlink shared channel belonging to a same DMRS CDM group.

Aspect 12: The method of any of aspects 1 through 11, further comprising: receiving both of a downlink shared channel of the set of downlink shared channels and the second downlink shared channel independent of an alignment between DMRS symbols of the downlink shared channel and DMRS symbols of the second downlink shared channel and independent of one or more DMRS ports of the downlink shared channel and one or more DMRS ports of the second downlink shared channel belonging to a same DMRS CDM group, wherein the downlink shared channel and the second downlink shared channel at least partially overlap in both time and frequency, and wherein the first pool index is different from the second pool index.

Aspect 13: The method of aspect 12, wherein the second downlink shared channel is associated with a semi-persistently scheduled downlink shared channel.

Aspect 14: The method of any of aspects 1 through 13, further comprising: activating a second set of SPS configurations for a second set of downlink shared channels associated with the second pool index and including the second downlink shared channel based at least in part on the control message and one or more additional control messages; determining to receive a first downlink shared channel over a third downlink shared channel of the set of downlink shared channels based at least in part on an SPS configuration index associated with the first downlink shared channel being lower than an SPS configuration index associated with the third downlink shared channel; and determining to refrain from receiving one or more of the second set of downlink shared channels based at least in part on the one or more of the second set of downlink shared channels at least partially overlapping in time and frequency with the first downlink shared channel.

Aspect 15: The method of aspect 14, wherein DMRS symbols of the first downlink shared channel and the one or more of the second set of downlink shared channels are misaligned.

Aspect 16: The method of any of aspects 14 through 15, wherein one or more DMRS ports of the first downlink shared channel and one or more DMRS ports of the one or more of the second set of downlink shared channels belong to a same DMRS CDM group.

Aspect 17: The method of any of aspects 14 through 16, further comprising: determining to receive a fourth downlink shared channel over a fifth downlink shared channel of remaining downlink shared channels of the second set of downlink shared channels based at least in part on an SPS configuration index associated with the fourth downlink shared channel being lower than an SPS configuration index associated with the fifth downlink shared channel.

Aspect 18: The method of any of aspects 1 through 17, further comprising: receiving the second downlink shared channel based at least in part on the second downlink shared channel being dynamically scheduled by the control message and at least partially overlapping in both time and frequency with at least one downlink shared channel of the set of downlink shared channels; and refraining from receiving the at least one downlink shared channel of the set of downlink shared channels.

Aspect 19: The method of aspect 18, wherein DMRS symbols of the at least one downlink shared channel and the second downlink shared channel are misaligned.

Aspect 20: The method of any of aspects 18 through 19, wherein a start symbol of the at least one downlink shared channel is a threshold number of symbols apart from an end of the control message.

Aspect 21: The method of any of aspects 18 through 20, wherein one or more DMRS ports of the at least one downlink shared channel and one or more DMRS ports of the second downlink shared channel belong to a same DMRS CDM group.

Aspect 22: The method of any of aspects 1 through 21, further comprising: receiving at least one of the set of downlink shared channels and the second downlink shared channel based at least in part on the second downlink shared channel at least partially overlapping in both time and frequency with the at least one of the set of downlink shared channels.

Aspect 23: The method of any of aspects 1 through 22, further comprising: transmitting an indication of a number of shared channels capable of being received by the UE; and determining to receive one or more of the set of downlink shared channels or the second downlink shared channel based at least in part on the number of shared channels capable of being received by the UE.

Aspect 24: The method of aspect 23, wherein the indication comprises a first number of shared channels of the first pool index capable of being received by the UE; and the indication comprises a second number of shared channels of the second pool index capable of being received by the UE.

Aspect 25: An apparatus for wireless communications at a UE, comprising a processor; memory coupled with the processor; and instructions stored in the memory and executable by the processor to cause the apparatus to perform a method of any of aspects 1 through 24.

Aspect 26: An apparatus for wireless communications at a UE, comprising at least one means for performing a method of any of aspects 1 through 24.

Aspect 27: A non-transitory computer-readable medium storing code for wireless communications at a UE, the code comprising instructions executable by a processor to perform a method of any of aspects 1 through 24.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
activating a set of semi-persistent scheduling configurations for a set of downlink shared channels for the UE, the set of downlink shared channels associated with a first pool index;
receiving a control message that indicates time-frequency resources for a second downlink shared channel for the UE, the second downlink shared channel associated with a second pool index;
determining whether to receive at least one of the set of downlink shared channels or the second downlink shared channel based at least in part on a time overlap of the set of downlink shared channels and the second downlink shared channel; and
receiving the at least one of the set of downlink shared channels, the second downlink shared channel, or both based at least in part on the determining.

2. The method of claim 1, further comprising:
determining to receive a first downlink shared channel of the set of downlink shared channels over a third downlink shared channel of the set of downlink shared channels based at least in part on a semi-persistent scheduling configuration index associated with the first downlink shared channel being lower than a semi-persistent scheduling configuration index associated with the third downlink shared channel.

3. The method of claim 1, further comprising:
activating a second set of semi-persistent scheduling configurations for a second set of downlink shared channels associated with the second pool index and including the second downlink shared channel based at least in part on the control message and one or more additional control messages; and
determining to receive the second downlink shared channel over a third downlink shared channel of the second set of downlink shared channels based at least in part on a semi-persistent scheduling configuration index associated with the second downlink shared channel being lower than a semi-persistent scheduling configuration index associated with the third downlink shared channel.

4. The method of claim 1, further comprising:
determining to receive a first downlink shared channel over a third downlink shared channel of the set of downlink shared channels based at least in part on a priority of the first downlink shared channel being higher than a priority of the third downlink shared channel.

5. The method of claim 1, further comprising:
activating a second set of semi-persistent scheduling configurations for a second set of downlink shared channels associated with the second pool index and including the second downlink shared channel based at least in part on the control message and one or more additional control messages; and
determining to receive the second downlink shared channel over a third downlink shared channel of the second set of downlink shared channels based at least in part on a priority of the second downlink shared channel being higher than a priority of the third downlink shared channel.

6. The method of claim 1, further comprising:
receiving both of a downlink shared channel of the set of downlink shared channels and the second downlink shared channel based at least in part on the second downlink shared channel being dynamically scheduled by the control message and the first pool index being different from the second pool index, wherein the downlink shared channel and the second downlink shared channel overlap in time.

7. The method of claim 1, further comprising:
determining to refrain from receiving one or more of the set of downlink shared channels based at least in part on the second downlink shared channel at least partially overlapping in time with the one or more of the set of downlink shared channels, wherein the second pool index is the same as the first pool index.

8. The method of claim 7, wherein a start symbol of the one or more of the set of downlink shared channels is a threshold number of symbols apart from an end of the control message.

9. The method of claim 1, further comprising:
receiving a downlink shared channel of the set of downlink shared channels or the second downlink shared channel according to a set of rules based at least in part on the downlink shared channel and the second downlink shared channel at least partially overlapping in both time and frequency.

10. The method of claim 9, wherein the set of rules indicates that only downlink shared channels associated with a given pool index are to be received by the UE based at least in part on demodulation reference signal (DMRS) symbols of the downlink shared channel and the second downlink shared channel being misaligned.

11. The method of claim 9, wherein the set of rules indicates that only downlink shared channels associated with a given pool index are to be received by the UE based at least in part on one or more demodulation reference signal (DMRS) ports of the downlink shared channel and one or more DMRS ports of the second downlink shared channel belonging to a same DMRS code division multiplexing (CDM) group.

12. The method of claim 1, further comprising:
receiving both of a downlink shared channel of the set of downlink shared channels and the second downlink shared channel independent of an alignment between demodulation reference signal (DMRS) symbols of the downlink shared channel and DMRS symbols of the second downlink shared channel and independent of one or more DMRS ports of the downlink shared channel and one or more DMRS ports of the second downlink shared channel belonging to a same DMRS code division multiplexing (CDM) group, wherein the downlink shared channel and the second downlink shared channel at least partially overlap in both time and frequency, and wherein the first pool index is different from the second pool index.

13. The method of claim 12, wherein the second downlink shared channel is associated with a semi-persistently scheduled downlink shared channel.

14. The method of claim 1, further comprising:
activating a second set of semi-persistent scheduling configurations for a second set of downlink shared channels associated with the second pool index and including the second downlink shared channel based at least in part on the control message and one or more additional control messages;
determining to receive a first downlink shared channel over a third downlink shared channel of the set of downlink shared channels based at least in part on a semi-persistent scheduling configuration index associated with the first downlink shared channel being lower than a semi-persistent scheduling configuration index associated with the third downlink shared channel; and
determining to refrain from receiving one or more of the second set of downlink shared channels based at least in part on the one or more of the second set of downlink shared channels at least partially overlapping in time and frequency with the first downlink shared channel.

15. The method of claim 14, wherein demodulation reference signal (DMRS) symbols of the first downlink shared channel and the one or more of the second set of downlink shared channels are misaligned.

16. The method of claim 14, wherein one or more demodulation reference signal (DMRS) ports of the first downlink shared channel and one or more DMRS ports of the one or more of the second set of downlink shared channels belong to a same DMRS code division multiplexing (CDM) group.

17. The method of claim 14, further comprising:
determining to receive a fourth downlink shared channel over a fifth downlink shared channel of remaining downlink shared channels of the second set of downlink shared channels based at least in part on a semi-persistent scheduling configuration index associated with the fourth downlink shared channel being lower than a semi-persistent scheduling configuration index associated with the fifth downlink shared channel.

18. The method of claim 1, further comprising:
receiving the second downlink shared channel based at least in part on the second downlink shared channel being dynamically scheduled by the control message and at least partially overlapping in both time and frequency with at least one downlink shared channel of the set of downlink shared channels; and
refraining from receiving the at least one downlink shared channel of the set of downlink shared channels.

19. The method of claim 18, wherein demodulation reference signal (DMRS) symbols of the at least one downlink shared channel and the second downlink shared channel are misaligned.

20. The method of claim 18, wherein a start symbol of the at least one downlink shared channel is a threshold number of symbols apart from an end of the control message.

21. The method of claim 18, wherein one or more demodulation reference signal (DMRS) ports of the at least one downlink shared channel and one or more DMRS ports of the second downlink shared channel belong to a same DMRS code division multiplexing (CDM) group.

22. The method of claim 1, further comprising:
receiving at least one of the set of downlink shared channels and the second downlink shared channel based at least in part on the second downlink shared channel at least partially overlapping in both time and frequency with the at least one of the set of downlink shared channels.

23. The method of claim 1, further comprising:
transmitting an indication of a number of shared channels capable of being received by the UE; and
determining to receive one or more of the set of downlink shared channels or the second downlink shared channel based at least in part on the number of shared channels capable of being received by the UE.

24. The method of claim 23, wherein:
the indication comprises a first number of shared channels of the first pool index capable of being received by the UE; and
the indication comprises a second number of shared channels of the second pool index capable of being received by the UE.

25. An apparatus for wireless communications at a user equipment (UE), comprising:
a processor,
memory coupled with the processor; and
instructions stored in the memory and executable by the processor to cause the apparatus to:
activate a set of semi-persistent scheduling configurations for a set of downlink shared channels for the UE, the set of downlink shared channels associated with a first pool index;
receive a control message that indicates time-frequency resources for a second downlink shared channel for the UE, the second downlink shared channel associated with a second pool index;
determine whether to receive at least one of the set of downlink shared channels or the second downlink shared channel based at least in part on a time overlap of the set of downlink shared channels and the second downlink shared channel; and
receive the at least one of the set of downlink shared channels, the second downlink shared channel, or both based at least in part on the determining.

26. The apparatus of claim 25, wherein the instructions are further executable by the processor to cause the apparatus to:
determine to receive a first downlink shared channel over a third downlink shared channel of the set of downlink shared channels based at least in part on a semi-persistent scheduling configuration index associated with the first downlink shared channel being lower than a semi-persistent scheduling configuration index associated with the third downlink shared channel.

27. The apparatus of claim 25, wherein the instructions are further executable by the processor to cause the apparatus to:
activate a second set of semi-persistent scheduling configurations for a second set of downlink shared channels associated with the second pool index and including the second downlink shared channel based at least in part on the control message and one or more additional control messages; and
determine to receive the second downlink shared channel over a third downlink shared channel of the second set of downlink shared channels based at least in part on a semi-persistent scheduling configuration index associated with the second downlink shared channel being lower than a semi-persistent scheduling configuration index associated with the third downlink shared channel.

28. The apparatus of claim 25, wherein the instructions are further executable by the processor to cause the apparatus to:
determine to receive a first downlink shared channel over a third downlink shared channel of the set of downlink shared channels based at least in part on a priority of the first downlink shared channel being higher than a priority of the third downlink shared channel.

29. An apparatus for wireless communications at a user equipment (UE), comprising:
means for activating a set of semi-persistent scheduling configurations for a set of downlink shared channels for the UE, the set of downlink shared channels associated with a first pool index;
means for receiving a control message that indicates time-frequency resources for a second downlink shared channel for the UE, the second downlink shared channel associated with a second pool index;
means for determining whether to receive at least one of the set of downlink shared channels or the second downlink shared channel based at least in part on a time overlap of the set of downlink shared channels and the second downlink shared channel; and
means for receiving the at least one of the set of downlink shared channels, the second downlink shared channel, or both based at least in part on the determining.

30. A non-transitory computer-readable medium storing code for wireless communications at a user equipment (UE), the code comprising instructions executable by a processor to:
activate a set of semi-persistent scheduling configurations for a set of downlink shared channels for the UE, the set of downlink shared channels associated with a first pool index;
receive a control message that indicates time-frequency resources for a second downlink shared channel for the UE, the second downlink shared channel associated with a second pool index;
determine whether to receive at least one of the set of downlink shared channels or the second downlink shared channel based at least in part on a time overlap of the set of downlink shared channels and the second downlink shared channel; and
receive the at least one of the set of downlink shared channels, the second downlink shared channel, or both based at least in part on the determining.
